(19) United States
(12) Patent Application Publication
(10) Pub. No.: US 2004/0080509 A1
(43) Pub. Date: Apr. 29, 2004

(54) Apparatus for determining constitution of user of the same

(75) Inventors: Kazuhiro Hosokawa, Aichi (JP); Hideki Hirabayashi, Mie (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignees: Kabushiki Kaisha Instem; Kabushiki Kaisha Genki Club

(21) Appl. No.: 10/601,498

(22) Filed: Jun. 23, 2003

Related U.S. Application Data
(63) Continuation of application No. PCT/JP01/11239, filed on Dec. 20, 2001.

(30) Foreign Application Priority Data
Jan. 12, 2001 (JP) 2001-5242
Sep. 17, 2001 (JP) 2001-280869

(51) Int. Cl. G06T 11/20

(52) U.S. Cl. 345/440

(57) ABSTRACT

This invention relates to a technology for determining the constitution of a human being by the use of a computer. For the purpose of a precise determination of the constitution, this invention is constructed such that the constitution is determined as one of a predetermined plurality of types, on the basis of a distribution pattern reflecting how a population consisting of tendencies of the human being to show with respect to respective items has been scattered over a range of ranks (ranging from a yin-rank to a yang-rank through a medium-rank) indicative of strengths of the tendencies. The plurality of types consist of basic or independent types A, B, C, D, and E, and compound types AB, AD, BC, CD, and E+.

### TECHNICAL FIELD

The present invention relates to a technology for determining the constitution of each one of individual human beings by the use of a computer.

### BACKGROUND ART

Originally, each one of individual human beings retains his or her constitution inherent to himself or herself, and therefore, more precisely, a plurality of human beings cannot share the same constitution. However, several existing proposed theories allow constitutions of all human beings to be classified into a limited number of types.

Recently, there has been indicated the strong relationship between foods that human beings eat and illnesses that human beings face. Described particularly, by way of example, the national report presented by the Government of the United States of America, called “McGovern's Report,” addressed that the diseases which form six major causes of death, such as a cancer, are recognized as “food-caused diseases,” meaning that all diseases are by root caused by foods.

Additionally, as an example, the United States Department of Agriculture categorized, in collaboration with the Ministry of Health, Labor and Welfare in the United States of America, the proper foods that human beings should eat, into five groups, for the purpose of presenting the dietary and lifestyle guidelines toward the twenty-first century, resulting in the creation of the food pyramid indicating the quantity of the proper foods that human being should eat, for each one of the above groups. The guidelines pointed out that a food is capable of functioning as a factor for causing a disease, and also as a factor for preventing a disease.

Although it will be apparent from the foregoing that the prevention of a disease requires human beings to eat the foods suitable for the purpose, it has been already pointed out, in addition to the above finding, that an issue of whether or not each food is suitable for each individual to eat, depends on his or her constitution.

Thus, it has been said that it is important for each individual to learn his or her constitution, from the perspective of practicing a proper diet and lifestyle, and it is also important from the perspective of mentally and spiritually normalizing each individual.

Furthermore, it is also important for each individual to learn his or her constitution, from the perspective of attempting to quickly recover, maintain, strengthen, etc., the each individual's health, for example.

Japanese publication of un-examined Utility Model application Showa 55-137614 discloses one example of a conventional technology of determining the constitution of each individual. According to this conventional technology, the constitution of each individual is determined on the basis of his or her answers to the questions that have been asked to him or her. Hereinafter, the each individual will be referred to as “answerer,” where appropriate.

According to the above conventional technology, described in more detail, there is utilized the constitution-determination table which is formed on a sheet of paper, and which identifies the contents of the above-mentioned questions with regard to a plurality of items.

The constitution-determination table bears, for each item, three columns provided for answering: a first column intended to be marked by the above answerer when he or she exhibits a yin-natured constitution; a second column intended to be marked by the same answerer when he or she exhibits a yang-natured constitution; and a third column intended to be marked by the same answerer when he or she exhibits a medium-natured constitution. The same answerer selects, for each item, a corresponding one of the three columns, and then marks the selected column.

The constitution-determination table further bears a column for indicating a determined constitution. In the column, the answerer distinguishably writes down three numbers: a first number which is the number of marks that the answerer has put in the above-indicated first column; a second number which is the number of marks that the same answerer has put in the above-indicated second column; and a third number which is the number of marks that the same answerer has put in the above-indicated third column.

Upon completion of thus marking the constitution-determination table, the above answerer himself or herself determines, by a three-stage process, his or her own constitution, i.e., whether his or her constitution is yin-, yang-, or medium-natured.

It is noted that being yin-natured means being biased in nature in one direction, as possibly called negative nature, while being yang-natured means being biased in nature in the opposing direction, as possibly called positive nature. It is also noted that being medium-natured means no bias in nature.

Described specifically, in the case where the above first number is larger than the above second number, the above answerer determines that his or her constitution is yin-natured, and conversely, in the case where the second number is larger than the first number, the above answerer determines that his or her constitution is yang-natured.

In addition, in the case where the first and the second number are both equal to zero, that is, where the answerer answered “medium” for every item, the answerer determines that his or her constitution is medium-natured.

Furthermore, in the case where the above third number is larger than the other two, if the first number is the second largest of all the three, the answerer can determine that his or her constitution is yin-natured, and on the other hand, if the second number is the second largest of all the three, the answerer can determine that his or her constitution is yang-natured.

### DISCLOSURE OF THE INVENTION

As will be readily understood from the foregoing, the conventional technology as explained above permits the answerer's constitution to be determined as any one of three types: a yin-; a yang-; and a medium-natured one. More specifically, when the above first number is not equal to zero but when the above second and the above third number are both equal to zero, the answerer's constitution is determined as a yin-natured type, for example.

However, in the above conventional technology, at the stage of determining an answerer's constitution, although there is considered the fact as to which one of the first and the second number is larger than the other, there is not considered the fact as to which the difference between the first and the second number is large or small, i.e., the extent of dispersion representative of whether the same answerer's answers are distributed over the range of columns, so as to be concentrated at one column, or so as to be scattered at more than one column.

For the above reason, in the above conventional technology, when the above first and the above second number are almost equal to each other, and when the above third number is smaller than the first and the second number, the above answerer's constitution is determined as the characteristic corresponding to the larger of the first and the second number. Here, the characteristic is concerned with whether the answerer's constitution is yin- or yang-natured.

On the other hand, the present inventors' research has revealed that it is impossible to match with a answerer's true constitution, the determination result of the answerer's constitution, which result is provided according to the rule that any individual's constitution is determined as a selected one of the above-mentioned three types in all cases.

In other words, when the tendencies or characteristics of an answerer to show in association with respective items for questions are not concentrated at one of a plurality of ranks with which each item is provided for the evaluation of the answerer's conformity in level, if the answerer's constitution is nevertheless qualified as any one of the above three types without considering the real fact as to the dispersion of the selected ranks for all the items, it cannot be said that the determination result of the answerer's constitution precisely reflects his or her true constitution. This will be described in more detail below.

According to the above finding, when the first and the second number are almost the same, and when the above third number is smaller than the first and the second number, like in the above exemplified case, while it is not proper to determine the answerer's constitution as a selected one of the above three types, it is proper to determine the answerer's constitution as the type for exhibiting a combination of a component of a yin-natured type and a component of a yang-natured type.

For the above reason, the aforementioned conventional technology is hard to precisely determine each individual's constitution.

It is therefore an object of the present invention to permit each individual's constitution to be determined more precisely.

The object may be achieved according to any one of the following modes of the present invention. Each of these modes of the present invention is numbered, and depends from the other mode or modes, where appropriate. This explanation about the present invention is for better understanding of some instances of a plurality of technological features and a plurality of combinations thereof disclosed in this specification, and does not mean that the plurality of technological features and the plurality of combinations in this specification are interpreted not to include ones other than the following modes of the present invention:

(1) An apparatus for determining a constitution of an arbitrary user of the apparatus, by the use of a computer, comprising:

rank selecting means for selecting, for each one of a plurality of items which are used for determination of the user's constitution, on the basis of data indicative of information with regard to the user himself or herself, at least one of a plurality of ranks which are used for quantitatively expressing a strength of a tendency of the user to show with regard to the each item; and

constitution displaying means for calculating, for the each item, on the basis of a selection result provided by the rank selecting means, and according to a predetermined point allocation which defines how may points are allocated to each one of the plurality of ranks when selected, a score of the each rank; for summing, for the each rank, a plurality of scores obtained by the calculating with regard to all the plurality of items, thereby determining, on the basis of a distribution pattern of a plurality of sums respectively obtained by the summing for the plurality of ranks, wherein the distribution pattern reflects how a population consisting of the plurality of sums is scattered over a range of the plurality of ranks, and according to a predetermined determination rule, the user's constitution as one of a predetermined plurality of types; and for displaying the determined constitution on a screen of the computer.

In this apparatus, there is selected, for each one of a plurality of items used for determining the user's constitution, on the basis of data indicative of information with regard to the user himself or herself, at least one of a plurality of ranks used for quantitatively expressing the strength of a tendency of the user to show with regard to each item. That is, the strength of the tendency of the user to show with regard to each item is quantified and processed in this apparatus.

Moreover, in this apparatus, there are calculated a score for each item and for each rank, on the basis of the selection result with regard to the plurality of ranks, and according to a predetermined point allocation defining how may points are allocated to each rank when selected.

Furthermore, in this apparatus, there are summed, for each rank, a plurality of scores obtained by the above-mentioned score calculation with regard to all the plurality of items.

In addition, in this apparatus, the user's constitution is determined, on the basis of a distribution pattern of a plurality of sums respectively obtained by the above summing for the plurality of ranks, and according to a predetermined determination rule, as one of a predetermined plurality of types. Wherein, the distribution pattern reflects how a population consisting of the plurality of sums is scattered or dispersed over a range of the plurality of ranks.

Then, in this apparatus, the thus determined constitution is displayed on a screen of the computer.

Therefore, this apparatus would enable the user's constitution to be determined as one of the predetermined plurality of types, so as to reflect, in the event, the distribution pattern in strength of a plurality of tendencies of the user to show, wherein the distribution pattern represents how the plurality of tendencies are dispersed, which is to say, whether the plurality of tendencies are concentrated at one rank, or scattered at more than one rank.

Accordingly, this apparatus would facilitate to precisely determine a user's constitution, compared with the above-mentioned conventional technology described in the above-identified Japanese publication of un-examined Utility Model Application Showa 55-137614, wherein the user's constitution is determined without considering how the above plurality of tendencies of the user to show are scattered. This will be described in more detail below.

Basically, a constitution of a human being can be categorized into three types.

In general, when a substance is heated to incandescence or to vaporization (or plasma), the substance emits a light. The wavelength of the emitted light varies according to the kinds of elements constituting the substance.

As one example of the approach to perform the qualitative and quantitative analysis of an element by taking advantage of the above property with regard to the wavelength, there is known the spectroscopic analysis employing the spectrum of an element to be analyzed. In this spectroscopic analysis, the wavelength of the light emitted from an element to be analyzed reflects the characteristics of the element.

An element can be categorized depending upon the magnitude of a centripetal force of a proton in the element, which force permits the proton to attract an electron in the element. That is, an element can be categorized into one having a strong centripetal nature (i.e., a strong nature to move near to the center) due to a large centripetal force of the proton; and one having a strong centrifugal nature (i.e., a strong nature to move away from the center) due to a large centrifugal force of the proton.

After an extremely high thermal energy is added to an element, when the amount and the strength of the thermal energy each exceed a threshold level, the thermal energy is transformed into a light energy, resulting in the emission of a photon from the element. The photon travels at a high speed during the spiral revolution thereof.

From the direction perpendicular to the direction of the photon to travel, the track along which the photon moves is observed as a wave. The length of the repetition unit of the wave of the photon is referred to as wavelength.

On the other hand, in the case of a small centripetal force of a proton in an element, the orbit along which its electron revolves in the element is large in diameter, and also the revolution velocity is high.

At the emission of a photon from one element, a high revolution velocity of its electron is accompanied by a high revolution velocity of the photon. Due to constancy in velocity of light, a high revolution velocity of the photon is accompanied by a large number of revolutions thereof; and a high density of the wave thereof. The high density is accompanied by a large number of the repetition units of the wave of the photon; and a short wavelength thereof.

The shorter the wavelength is, the higher the frequency of the wave is, and the higher the vibration energy of the photon is. It results in a large force of the photon to apply to other substances.

Consequently, in general, the stronger the centrifugal nature of the proton is, the higher the revolution velocity of the electron is, and the larger the applying force of the photon is.

Hereinafter, an element which is shorter in the wavelength of light emitted from the element, and which is strong in the centrifugal nature will be referred to as “yin-natured element,” and, at the same time, an element which is longer in the wavelength of light emitted from the element, and which is strong in the centripetal nature will be referred to as “yang-natured element.”

An element emitting light whose wavelength ranges from 3,500 to 5,000 angstrom, i.e., an element whose wavelength is shorter, is classified as the above-defined yin-natured element with its strong centrifugal nature. The examples are such as kalium, oxygen, phosphorus, sulfur, calcium, etc.

Alternatively, an element emitting light whose wavelength ranges from 5,000 to 8,000 angstrom, i.e., an element whose wavelength is longer, is classified as the above-defined yang-natured element with its strong centripetal nature. The examples are such as natrium, hydrogen, carbon, magnesium, etc.

It is added that the values of the above-mentioned wavelengths have been derived from data disclosed in the atlas appearing typical photographs of spectrum, titled “ATLAS TIPISCHEN SPECTREN,” co-authored by Dr. J. M. Adair and Prof. Y. E. Valenta; and the literature titled “Table of Spectrum,” authored by Keisel. These values are addressed in the literature titled “ONE AND ONLY THEORY. DIVINATION,” authored by SAKURAZAWA Nyoichi, published by Japan CI Association.

As widely known, fundamental elements constituting a human body range from oxygen, carbon, hydrogen, nitrogen, calcium, phosphorus, sulfur, kalium, natrium, chlorine, magnesium, etc., to approximately fifty other kinds of elements.

As described above, each element retains, in association with its proton, both the centripetal nature, i.e., a yang-nature, and the centrifugal nature, i.e., a yin-nature. The centripetal and the centrifugal nature are considered as two natures (or tendencies) contrary to each other. However, each element is biased toward either of the yang- and a yin-nature.

Accordingly, it follows that each element apparently represents the more dominant of the yang- and a yin-nature. That is, the representative nature of each element depends on the difference in strength between the yang- and a yin-nature included in the each element.

A human body is constructed as a result of combining an immense number of elements and highly organizing them. Accordingly, whether the whole of the elements constituting a human body is biased to either the yin- or a yang-nature, and whether how strong the bias is determine the characteristic of the entire of the above high organization, namely, the constitution which the human being bears.

As will be readily understood from the above that, eventually, the constitution of a human being can be basically generally classified into the yin- and a yang-nature, and a medium-nature placed at the intermediate point between the yin- and a yang-nature.

However, the present inventors' research has found that it is not enough to solely generally classify the constitution of a human being into the yin-, the yang-, and a medium-nature, that is, to solely determine the constitution as any one of the three natures: the yin-, the yang-, and a medium-nature, as described above.

The above research has also disclosed that it is necessary, in order to achieve a precise determination of the constitution, to perform the above classification in view of one or more compound types each obtained by compounding selected ones of these three basic types.

Hereinafter, there will be described the fact that not only these three basic types: the yin-, the yang-, and a medium-nature but also one or more compound types coexist, through the approach to classify the constitution of a human being according to the feature of the red blood cell of the human being, which approach functions as one to objectively classify the constitution of the human being.

The major roles which the blood plays in a human body include: to convey necessary substances into various pieces of tissue of the human body; and to convey waste substances into the excretion organ of the human body. The major roles further include: to eliminate substances harmful to the human body, and germ; to protect the mode of life of the human body; to maintain the homeostasis of the inside condition of the human body; to evenly distribute the body temperature over the whole of the human body; and so on.

These findings help us to readily learn about the close relationship between the physiological functions and the blood, of the human body.

The blood consists of a liquid component as called blood plasma; and a cell component floating in the blood plasma. The blood plasma occupies 55 percent of the whole blood, as made up of water, protein, blood sugar, lipid, inorganic salt and the like, nitrogen compound, etc.

In addition, the above cell component occupies 45 percent of the whole blood, as made up of the red blood cell; the white blood cell; and the blood platelet.

The red blood cell is formed as a flat blood cell with a diameter of 8 μm. The major component of the red blood cell is the hemoglobin, contributing to the conveyance of oxygen and carbon dioxide, and to the maintenance of the acid-base equilibrium. The red blood cell contains various kinds of the blood group substances, thereby determining the blood group or blood type of each human being.

There is presently known the term “blood image.” This term means the condition of the cell component of the blood, as used when collectively indicating the number, shapes, and sizes of the red blood cells; the number of the white blood cells; the distribution ratio between them; the fact as to whether or not each cell has abnormality in form is shown; etc. The above blood image is useful in performing diagnosis because of its change depending upon the kind of sickness that a human being suffers.

These findings help us to readily learn about the close relationship between the constitution, i.e., the physical properties (physiological or pathological characteristics), and the condition of the red blood cell, of a human being.

As will be evident from the foregoing, the above approach to classify the constitution of a human being depending upon the condition of the red blood cell is valid in realizing one approach to objectively classify the constitution of a human being.

Referring now to FIGS. 33 to 44, there are shown respective images of a plurality of blood samples taken from the bodies of a plurality of human beings, in the form of respective micrographs taken under a phase-contrast microscope.

FIGS. 33, 37 and 41 show the micrographs that were taken of the respective blood samples, immediately after being taken from the bodies of respective human beings, while FIGS. 34 to 44 excepting FIGS. 37 and 41 show the respective micrographs that were taken of the respective blood samples after being cultured under a predetermined condition. Apparently, these micrographs demonstrate that the red blood cells in the blood samples have a plurality of types in size and shape.

It is added that those micrographs of the pre-cultured blood samples were taken under the following conditions:

Immediately after taking the blood (i.e., the whole blood) as a sample from the fingertip of the subject human being, the blood sample is put on a slide glass used for the microscope as expeditiously as possible, and subsequently, the blood sample on the slide glass is covered with a cover glass used for the microscope. Besides that, the periphery of the cover glass is sealed with oil that is intended for use under the immersion method in association with the microscope, whereby the blood sample is put under such a condition that the blood sample is isolated from oxygen. Under the anaerobic condition, the above micrographs were taken.

It is also added that the blood sample is cultured as follows:

The above pre-cultured blood sample is put into a culture device at a temperature of 38 degrees centigrade. The blood sample is stored within the culture device for a predetermined length of time (e.g., three days, a couple of days, one week, two weeks).

The red blood cell can be generally classified depending upon its size and shape, into the following three basic types:

an expanded blood cell type, wherein the red blood cell is larger in diameter, and its cell membrane is thinner;

a contracted blood cell type, wherein the red blood cell is smaller in diameter, and its cell membrane is thicker; and

a medium blood cell type situated as an intermediate between the former two types.

The relationship between these three blood cell types and the constitutions of human beings is considered as follows:

The expanded blood cell type corresponds to the previously mentioned yin-natured constitution (with the centrifugal property), the contracted blood cell type corresponds to the previously mentioned yang-natured constitution (with the centripetal property), and the medium blood cell type corresponds to the previously mentioned medium-natured constitution.

Referring next to FIGS. 33, 37 and 41, there are shown the micrographs of the respective pre-cultured blood samples. If these micrographs are classified as any one of the yin-, the yang-, and a medium-nature according to the above-mentioned classification rule, it follows that the micrographs of FIGS. 33, 37 and 41 correspond to the yin-, the medium-, and a yang-nature, respectively.

Thus, it is recognized that the condition of the pre-cultured blood sample would permit the constitution of a human being to be classified as any one of three basic types: the yin-, the yang-, and a medium-nature.

It is further recognized that the condition of the cultured blood sample, whose attribute has been highlighted as a result of culturing the original blood sample, would permit the constitution of a human being to be classified as any one of types including those three basic types and other types. This will be described in more detail below.

As shown in FIG. 33, in the case of the pre-cultured red blood cell which has been determined as a yin-nature in view of the micrograph of the pre-cultured blood sample, after culturing the pre-cultured blood sample, there arise the instance where the cultured red blood cell strongly shows a yin-nature, as shown in FIG. 34; the instance where it normally shows a yin-nature, as shown in FIG. 35; and the instance where it shows not only a yin-nature but also a yang-nature, as shown in FIG. 36.

The finding that the cultured red blood cell strongly shows a yin-nature in FIG. 34 has been derived from the fact that, by comparison with FIG. 33, the red blood cell has been expanded, resulting in the observation of a large number of red blood cells whose cell membranes are thinner, and which are during the course of the hemolysis.

Moreover, the finding that the cultured red blood cell normally shows a yin-nature in FIG. 35 has been derived from the fact that, unlike in FIG. 34, there are few red blood cells that are during the course of the hemolysis.

Furthermore, the finding that the cultured red blood cell shows not only a yin-nature but also a yang-nature in FIG. 36 has been derived from the fact that, by comparison with FIG. 33, the red blood cells each have a large number of dents on the surfaces of their cell membranes, demonstrating a tendency of the cells to be contracted.

In addition, as shown in FIG. 37, in the case of the pre-cultured red blood cell which has been determined as a medium-nature in view of the micrograph of the pre-cultured blood sample, after culturing the pre-cultured blood sample, there arise the instance where the cultured red blood cell shows not only a medium-nature but also a yin-nature, as shown in FIG. 38; the instance where it normally shows a medium-nature, as shown in FIG. 39; and the instance where it shows not only a medium-nature but also a yang-nature, as shown in FIG. 40.

The finding that the cultured red blood cell shows not only a medium-nature but also a yin-nature in FIG. 38 has been derived from the fact that, by comparison with FIG. 37, the red blood cell has been dilated, resulting in a tendency of the cell to be expanded.

Moreover, the finding that the cultured red blood cell normally shows a medium-nature in FIG. 39 has been derived from the fact that, unlike in FIG. 38, there are red blood cells having neither a tendency to be expanded nor a tendency to be contracted.

Furthermore, the finding that the cultured red blood cell shows not only a medium-nature but also a yang-nature in FIG. 40 has been derived from the fact that, by comparison with FIG. 37, the red blood cells each have a large number of dents on the surfaces of their cell membranes, demonstrating a tendency of the cells to be contracted.

In addition, as shown in FIG. 41, in the case of the pre-cultured red blood cell which has been determined as a yang-nature in view of the micrograph of the pre-cultured blood sample, after culturing the pre-cultured blood sample, there arise the instance where the cultured red blood cell strongly shows a yang-nature, as shown in FIG. 42; the instance where it normally shows a yang-nature, as shown in FIG. 43; and the instance where it shows not only a yang-nature but also a yin-nature, as shown in FIG. 44.

The finding that the cultured red blood cell strongly shows a yang-nature in FIG. 42 has been derived from the fact that, by comparison with FIG. 41, due to a tendency of the red blood cells to be contracted, their cell membranes have become thicker, resulting in the observation of a large number of red blood cells whose cell membranes have been reduced in transparency.

Moreover, the finding that the cultured red blood cell normally shows a yang-nature in FIG. 43 has been derived from the fact that, unlike in FIG. 42, there are few red blood cells each having a strong tendency to be contracted.

Furthermore, the finding that the cultured red blood cell shows not only a yang-nature but also a yin-nature in FIG. 44 has been derived from the fact that, by comparison with FIG. 41, the red blood cells, due to its tendency to be expanded, have been dilated.

As will be apparent from the foregoing, the conditions of the cultured red blood cells demonstrate that the types of the red blood cells include three basic types: a normal yin-nature, a normal yang-nature, and a normal medium-nature; and a plurality of compound types obtained by compounding selected ones of those basic types. This teaches that the types of the constitutions of human beings similarly include three basic types, and a plurality of compound types.

Therefore, for the purpose of precisely determining the constitution of a human being, it is not enough to determine the constitution as any one of solely the three basic types as a result of collectively considering the selection results of the previously mentioned ranks, and it is necessary to consider how these selection results are dispersed.

Based on the above findings, in the apparatus according to the present mode (1), the constitution of a human being is capable of being precisely determined by considering the fact as to whether the tendencies that the same human being exhibits with regard to the plurality of items have been distributed over the range of the plurality of ranks, so as to be concentrated at one rank, or so as to be dispersed at more than one rank.

As previously explained, the rule to generally classify the constitution of a human being into the yin-, the yang-, and a medium-nature from the perspective of the centripetal and the centrifugal property, as previously described, is one of the rules to classify the constitution of a human being. This rule is considered as one example to generally classify the constitution of a human being into two opposite properties and an intermediate property therebetween.

The apparatus according to the present mode (1) may be applied to an apparatus in which the constitution of a human being is classified according to a rule other than the rule as specifically described above. According to one example of the other rule, the constitution of a human being is generally classified into an ideal; an acid; and an alkaline type.

The “computer” in the present mode (1) may be constructed as that of a standalone type, or that of a network type connected through a communication network with other computers, for example.

The network type computer functions as a server computer for providing information in one case, and as a client computer for receiving information in another case.

In both cases, the “screen” in the present mode (1) means not a screen of the above server computer, but a screen of the above client computer, because a computer directly used by the above-mentioned user means the client computer.

In addition, in both cases, while it is the client computer that directly displays the content of information on its screen, it is the server computer that instructs the client computer to display. Therefore, the computer for displaying, either directly or indirectly, may be considered as the client computer, or as the server computer.

By taking notice of the above findings, when the “screen” in the present mode (1) is constructed as a screen of the client computer for the business use, the constitution displaying means in the present mode (1) may be constructed within the client computer, and also may be constructed within the server computer.

Alternatively, when the “screen” in the present mode (1) is constructed as a screen of the client computer for the personal or family use, the constitution displaying means in the present mode (1) may be constructed within the server computer.

Moreover, the “computer” in the present mode (1) may be constructed in the form of a computer system in which a plurality of client computers are connected through a communication network with a server computer.

Furthermore, the “computer” in the present mode (1) may be used for various applications and may be constructed in various forms. More specifically, the computer may mean a general-purpose computer; a computer incorporated into a mobile telephone, such as a portable telephone or a PHS (Personal Handy-phone System); or a computer incorporated into a PDA (Personal Digital Assistant) in which a communication function has been added to an electrically recording function.

Although the interpretation of the “computer” and the “screen” in the present mode (1) was described above, this interpretation is applicable to the following modes as described later.

In addition, although the “user” in the present mode (1) is an individual whose constitution is to be determined, it is not essential for the user himself or herself to directly operate the computer in the present mode (1) for the determination of his or her constitution. The apparatus according to the present mode (1) may be practiced in the form where the user's constitution is determined as a result of operation by a person other than the user.

(2) The apparatus according to the above mode (1), wherein the data indicative of information with regard to the user himself or herself includes at least one of input data entered by the user; sample condition data indicative of a condition of a sample taken from a human body of the user; image data indicative of an image of at least one portion of the human body of the user; and voice data indicative of voice made by the user.

The “sample” in the present mode (2) may be the blood of the user (in particular, the red blood cells, the white blood cells, the blood platelets, etc., for example).

The “sample” further maybe such as the hairs, the nails, the urine, the excrement, of the user.

In addition, while the user's answers to given questions tend to be subjective, the “image data” in the present mode (2) is capable of being used for an objective evaluation of the above tendencies of the user to show with regard to each item for the questions, for example.

This “image data” is useful when it is necessary to objectively identify the geometries of each organ constituting the user's face, for example. In this case, when it is important to consider the size of each organ, the “image data” is preferably produced so as to specify the absolute dimension in size of each organ.

In addition, the “voice data” in the present mode (2) is useful when it is necessary to objectively determine the wavelength of the voice made by the user, for example.

(3) The apparatus according to the above mode (1), wherein the rank selecting means includes:

questions displaying means for displaying on the screen questions which are to be answered by the user, wherein the questions are constructed, such that the questions are classified into the plurality of items, and such that the questions bear the plurality of ranks for the each item; and

selecting means for selecting at least one of the plurality of ranks, on the basis of input data entered by the user according to contents of the questions displayed on the screen.

The “input data” in the present mode (3) is one example of the “data indicative of information with regard to the user himself or herself” in the above mode (1).

In addition, as to the relationship between the input data; and selection result data indicative of the selection result provided by the above selecting means, the input data as such may become the selection result data, and alternatively, the selection result data may be produced on the basis of the input data.

(4) An apparatus for determining a constitution of an arbitrary user of the apparatus, by the use of a computer, comprising:

questions displaying means for displaying on a screen of the computer questions which are to be answered by the user, wherein the questions are constructed, such that the questions are classified into a plurality of items which are used for determination of the user's constitution, and such that the questions bear, for each one of the plurality of items, a plurality of ranks which are used for quantitatively expressing a strength of a tendency of the user to show with regard to the each item, wherein at least one of the plurality of ranks is to be selected by the user for the each item; and

constitution displaying means for selecting, for the each item, on the basis of data indicative of the user's answers to the questions displayed on the screen, at least one of the plurality of ranks; for calculating, on the basis of a selection result obtained by the selecting, and according to a predetermined point allocation which defines how may points are allocated to each one of the plurality of ranks when selected, a score of the each rank; for summing, for the each rank, a plurality of scores obtained by the calculating with regard to all the plurality of items, thereby determining, on the basis of a distribution pattern of a plurality of sums respectively obtained by the summing for the plurality of ranks, wherein the distribution pattern reflects how a population consisting of the plurality of sums is scattered over a range of the plurality of ranks, and according to a predetermined determination rule, the user's constitution as one of a predetermined plurality of types; and for displaying the determined constitution on the screen.

In this apparatus, questions are displayed on the screen, and at least one of a plurality of ranks is selected, for each one of a plurality of items, on the basis of data indicative of the user's answers to the displayed questions. Wherein, the plurality of items are used for determining the user's constitution, and the plurality of ranks are used for quantitatively expressing a strength of a tendency of the user to show with regard to each item.

Further, in this apparatus, the user's constitution is determined as one of a predetermined plurality of types, on the basis of the above selection result obtained by the selecting, and in light of a distribution pattern of the plurality of sums as described above, similarly with the apparatus according to the above mode (1). Wherein, the distribution pattern reflects the degree of the dispersion of the plurality of sums over the range of the plurality of ranks.

Consequently, the apparatus according to the present mode (4) would provide the same functions and results as the apparatus according to the above mode (1) would provide, under the same principle as the latter apparatus employs.

The “plurality of items” of the questions in the present mode (4) are advantageously constructed to include ones defined using expressions absolute to the user. The absolute expressions may include, for example, such as a numeral expression for the user's body temperature, or an illustrative expression for a specific organ of the user's face, etc.

A relative expression, contrary to the above absolute expression, may include, for example, such as one as to whether the user's body temperature is high or low, or one as to whether a specific organ of the user's face is large or small.

In general, the confidence level in a user's answers to questions is higher when these questions are absolutely expressed than when relatively expressed.

In view of the above finding, when the apparatus according to the present mode (4) is practiced in such an arrangement that the “plurality of items” of the questions include ones absolutely expressed, the confidence level in the user's answers, and eventually the confidence level in the determination by this apparatus, is more improved than when the apparatus according to the present mode (4) is practiced in such an arrangement that the “plurality of items” of the questions include no expression absolutely expressed.

(5) The apparatus according to the above mode (4), wherein the questions displaying means displays the questions on the screen at at least two separate times, irrespective of whether or not parts of the questions which are displayed at the at least two separate times, respectively, are overlapped in content to each other; and

the constitution displaying means includes:

(a) provisionally determining means for obtaining the plurality of sums, on the basis of data indicative of the user's answers to part of the questions which is displayed at a first time on the screen by the questions displaying means; and for provisionally determining the user's constitution as at least one of the plurality of types, on the basis of the distribution pattern of the obtained plurality of sums, and according to a predetermined first determination rule; and

(b) finally determining means for finally determining the user's constitution as one of the provisionally determined at least one type, on the basis of data indicative of the user's answers to part of the questions which is displayed at a time succeeding the first time on the screen by the questions displaying means, and according to a predetermined second determination rule.

In this apparatus, the user's constitution is provisionally determined as at least one of a plurality of types, on the basis of data indicative of the user's answers to part of the questions which is displayed on the screen at a first time, and according to a first determination rule, and subsequently, the user's constitution is finally determined as one of the provisionally determined at least one type, on the basis of data indicative of the user's answers to part of the questions which is displayed on the screen at the succeeding time, and according to a predetermined second determination rule.

Consequently, this apparatus would provide, because of its capability of employing a combination of different determination rules, an improved precision of the determination result of the user's constitution, under the situation where, for example, it is necessary to prepare a complex relationship between a plurality kinds of answers presupposed for the same question; and a plurality kinds of types of constitutions presupposed for almost all of human beings, in order for the constitution of an arbitrary user to be precisely determined.

(6) The apparatus according to any one of the above modes (1) to (5), wherein the number of the plurality of ranks is larger than that of at least one basic type among the predetermined plurality of types, which basic type is established independently of other types.

This apparatus would permit to quantify (or numerically express, evaluate) the user's information (including the user's answers) at shortened intervals, compared with the case where the number of ranks is equal to that of the basic types, contributing to a precise recognition of the user's physical condition.

(7) The apparatus according to any one of the above modes (1) to (6), wherein the predetermined plurality of types comprise a plurality of basic types each of which is established independently of other types; and at least one compound type obtained by compounding selected ones of the plurality of basic types, and

the constitution displaying means determines, when the distribution pattern demonstrates that the plurality of sums are distributed so as to be scattered at ones of the plurality of ranks, the user's constitution as one of the at least one compound type.

(8) The apparatus according to the above mode (7), wherein the tendency of the user to show with regard to a content of the each item is defined as to whether the user's constitution bears a yin-, an yang-, or a medium-nature, and

the predetermined plurality of types include type A showing that the user's constitution bears a yin-nature; type D showing that it bears a yang-nature; and type E showing that it bears a medium-nature, and

the predetermined plurality of types further include as one of the at least one compound type, type AD showing that the user's constitution bears a combination of a component of type A and a component of type D.

(9) The apparatus according to any one of the above modes (1) to (8), wherein the tendency of the user to show with regard to a content of the each item is defined as to whether the user's constitution bears a yin-, an yang-, or a medium-nature,

the plurality of ranks at least include, for the each item:

a yin-rank to be selected when the user's constitution bears a yin-nature;

a yang-rank to be selected when the user's constitution bears a yang-nature; and

a medium-rank to be selected when the user's constitution bears a medium-nature,

the predetermined plurality of types at least include:

type A showing that the user's constitution bears a yin-nature;

type D showing that the user's constitution bears a yang-nature; and

type E showing that the user's constitution bears a medium-nature,

wherein these three types function as a plurality of basic types, each of which is established independently of other types,

the predetermined plurality of types further include type AD showing that a component of type A and a component of type D coexist in the user's constitution, as a compound type obtained by compounding selected ones of the plurality of basic types, and

the constitution displaying means determines the user's constitution as type A when the plurality of sums are distributed so as to be concentrated at the yin-rank; as type D when they are distributed so as to be concentrated at the yang-rank; as the type E when they are distributed so as to be concentrated at the medium-rank; as type AD when they are distributed so as to be scattered at the yin- and the yang-rank and when they are more intensively distributed at the yin- and the yang-rank than at other rank.

This apparatus would provide one preferable arrangement in which the apparatus according to any one of the above modes (1) to (8) is practiced.

(10) The apparatus according to any one of the above modes (1) to (8), wherein the tendency of the user to show with regard to a content of the each item is defined as to whether the user's constitution bears a yin-, an yang-, or a medium-nature,

the plurality of ranks at least include, for the each item:

a strong-yin-rank to be selected when the user's constitution strongly bears a yin-nature;

a weak-yin-rank to be selected when the user's constitution slightly bears a yin-nature;

a weak-yang-rank to be selected when the user's constitution slightly bears a yang-nature;

a strong-yang-rank to be selected when the user's constitution strongly bears a yang-nature; and

a medium-rank to be selected when the user's constitution bears a medium-nature,

the predetermined plurality of types at least include:

type A showing that the user's constitution strongly bears a yin-nature;

type B showing that the user's constitution slightly bears a yin-nature;

type C showing that the user's constitution slightly bears a yang-nature;

type D showing that the user's constitution strongly bears a yang-nature; and

type E showing that the user's constitution bears a medium-nature,

wherein these three types function as a plurality of basic types, each of which is established independently of other types,

the predetermined plurality of types further include at least one of type AD showing that a component of type A and a component of type D coexist in the user's constitution, to approximately the same extent as each other, and more distinguishably than possible components of other basic types exist; and type BC showing that a component of type B and a component of type C coexist in the user's constitution, to approximately the same extent as each other, and more distinguishably than possible components of other basic types exist, each of which type functions as a compound type obtained by compounding selected ones of the plurality of basic types,

the constitution displaying means includes means for determining the user's constitution as type A when the plurality of sums are distributed so as to be concentrated at the strong-yin-rank; as type B when they are distributed so as to be concentrated at the weak-yin-rank; as type C when they are distributed so as to be concentrated at the weak-yang-rank; as type D when the plurality of sums are distributed so as to be concentrated at the strong-yang-rank; and as the type E when they are distributed so as to be concentrated at the medium-rank,

the constitution displaying means further includes at least one of means for determining the user's constitution as type AD when the plurality of sums are distributed so as to be scattered at the strong-yin- and the strong-yang-rank and when are more intensively distributed at the strong-yin- and the strong-yang-rank than at other ranks; and means for determining the user's constitution as type BC when the plurality of sums are distributed so as to be scattered at the weak-yin- and the weak-yang-rank and when are more intensively distributed at the weak-yin- and the weak-yang-rank than at other ranks.

This apparatus would provide another preferable arrangement in which the apparatus according to any one of the above modes (1) to (8) is practiced.

(11) The apparatus according to the above mode (10), wherein the predetermined plurality of types further include type E+showing that a component of type A, a component of type B, a component of type C, and a component of type D coexist in the user's constitution, to approximately the same extent as each other, and

the constitution displaying means includes means for determining the user's constitution as type E+ when the plurality of sums are distributed so as to be scattered at the strong-yin- and the strong-yang-, the weak-yin-, the weak-yang, and the strong-yang-rank.

This apparatus would provide another preferable arrangement in which the apparatus according to any one of the above modes (1) to (8) is practiced.

According to one example of the “means” in the present mode (11), the user's constitution is determined as type E+ when the plurality of sums are distributed so as to be scattered at the strong-yin-, the weak-yin-, the weak-yang-, and the strong-yang-rank, and when more intensively distributed at the strong-yin-, the weak-yin-, the weak-yang-, and the strong-yang-rank than at other rank.

According to another example of the “means” in the present mode (11), the user's constitution is determined as type E+ when the plurality of sums are distributed so as to be scattered at the strong-yin-, the weak-yin-, the medium-, the weak-yang-, and the strong-yang-rank.

(12) The apparatus according to the above mode (10) or (11), wherein the predetermined plurality of types further include, as the compound type, at least one of type AB showing that a component of type A and a component of type B coexist in the user's constitution, to approximately the same extent as each other, and more distinguishably than possible components of other basic types exist; and type CD showing that a component of type C and a component of type D coexist in the user's constitution, to approximately the same extent as each other, and more distinguishably than possible components of other basic types exist,

the constitution displaying means further includes at least one of means for determining the user's constitution as type AB when the plurality of sums are distributed so as to be scattered at the strong-yin- and the weak-yin-rank and when are more intensively distributed at the strong-yin- and the weak-yin-rank than at other ranks; and means for determining the user's constitution as type CD when the plurality of sums are distributed so as to be scattered at the weak-yang- and the strong-yang-rank and when are more intensively distributed at the weak-yang- and the strong-yang-rank than at other ranks.

This apparatus would provide further preferable arrangement in which the apparatus according to any one of the above modes (1) to (8) is practiced.

(13) The apparatus according to any one of the above modes (1) to (12), wherein the constitution displaying means includes an obesity-related constitution displaying means for determining and displaying the user's obesity-related constitution.

This apparatus would permit the user's constitution to be determined by relying on the user's obesity-related nature.

Consequently, this apparatus would contribute to, when the user is of concern to his or her specific constitution relating to obesity rather than his or her generic constitution, the capability to readily satisfy his or her concern.

(14) The apparatus according to any one of the above modes (1) to (13), further comprising:

a constitution history memory for storing the determined constitution in association with an identity of the user; and

a constitution history displaying means for reading in from the constitution history memory the user's constitution history and displaying the constitution history on the screen, responsive to a request from the user to refer to his or her constitution history.

This apparatus, since is capable of storing the history of the determination results of the constitution in association with the identity of the user, would enable the user to readily check a change in the determination results, by comparing a newest determination result with a previous one.

As a result, this apparatus would permit the user to readily evaluate, by depending upon a change in the determination results, whether or not the user's existing policy for improvement of his or her constitution was effective, for example.

(15) The apparatus according to any one of the above modes (1) to (14), wherein the plurality of items include at least one of features of a plurality of visible elements constituting a human body of the user; a feature of each one of a plurality of organs constituting the user's face; a feature of the user's hair; a feature of the user's voice; how the user walks; the user's body temperature; a feature of the user's blood; at least one of a level and a mode, of the user's blood pressure; at least one of a feature of the user's excreta and how often or how much the user excretes; the user's bias of taste; and the user's mental or spiritual feature.

(16) The apparatus according to anyone of the above modes (1) to (15), wherein the computer includes:

a client computer with the screen, used by the user; and

a server computer connected to the client computer through a communication network, wherein the server computer sends through the communication network to the client computer an instruction for displaying on the screen, thereby instructing the client computer to display on the screen by following the transmitted instruction.

(17) A server computer which is connected through a communication network to a client computer with a screen as used by a user, and which is operated to determine the user's constitution, comprising:

rank selecting means for selecting, for each one of a plurality of items which are used for determination of the user's constitution, on the basis of data indicative of information with regard to the user himself or herself, at least one of a plurality of ranks which are used for quantitatively expressing a strength of a tendency of the user to show with regard to the each item; and

constitution displaying means for calculating, for the each item, on the basis of a selection result provided by the rank selecting means, and according to a predetermined point allocation which defines how may points are allocated to each one of the plurality of ranks when selected, a score of the each rank; for summing, for the each rank, a plurality of scores obtained by the calculating with regard to all the plurality of items, thereby determining, on the basis of a distribution pattern of a plurality of sums respectively obtained by the summing for the plurality of ranks, wherein the distribution pattern reflects how a population consisting of the plurality of sums is scattered over a range of the plurality of ranks, and according to a predetermined determination rule, the user's constitution as one of a predetermined plurality of types; and for instructing the client computer to display the determined constitution on the screen.

This server computer would provide the same functions and results as the apparatus according to the above mode (1) would provide, under the same principle as the latter apparatus employs.

The server computer according to the present mode (17) may be practiced by applying with necessary modifications an arrangement set forth in any one of the above modes (2) to (16).

(18) A system for supporting, by the use of a computer with a screen, in advising for a user of the system a proper-diet-plan suitable to the user, comprising:

the apparatus defined in any one of the above modes (1) to (16);

a proper-diet-plan memory in which there has been stored a relationship between a plurality kinds of constitutions presupposed for human beings, and a plurality kinds of proper-diet-plans presupposed for human beings' diets; and

proper-diet-plan displaying means for retrieving in the proper-diet-plan memory the proper-diet-plan suitable to the user, on the basis of the constitution determined by the apparatus defined in any one of the above modes (1) to (16); and for displaying the retrieved proper-diet-plan on the screen.

This system, since is capable of providing a proper-diet-plan compatible with a precisely determined constitution of the user, would permit to support the user in selecting proper foods and beverages which are appropriate for the user to take for his or her improved constitution.

The “proper-diet-plan” in the present mode (18) may be interpreted to include a proper plan for a human being's habit of taking a generic food (containing a so-called health food); and may be interpreted to include a proper plan for a human being's habit of taking all the substances, such as a healthfully functional food containing a nutritiously functional food and a specified for health food, a supplementary food, etc.

(19) The system according to the above mode (18), wherein each of the plurality kinds of proper-diet-plans is defined to provide a proper diet which is suitable to the user's constitution, and which contributes to an improvement in the user's constitution toward a medium one, in the form of a recipe for practicing the proper diet.

The system according to the above mode (18) may be practiced in an arrangement where each proper-diet-plan provides the user with a proper diet or a proper meal in the form of materials for practicing the proper diet which is suitable to the user's constitution and which contributes to an improvement in the user's constitution toward a medium one, namely, an ideal one.

However, this arrangement would require the user himself or herself or a person concerned to select ones of the provided materials and to practice the proper diet using the selected materials, in order for the user to take the proper diet suitable to his or her constitution, eventually necessitating the user's or the person's labor.

Alternatively, the system according to the present mode (19) would permit each proper-diet-plan to provide the user with the proper diet in the form of a recipe for practicing the proper diet.

Accordingly, the system according to the present mode (19) would enable the user or a person concerned to practice the proper diet suitable to his or her constitution, without selecting materials thereof beforehand in every and each practice of the proper diet, readily resulting in reduction in time and effort to be required.

According to one arrangement of the “proper-diet-plan” in the present mode (19), the recipe of the proper diet is provided to the user so as to display on the screen a staple food, a side dish, and a beverage, separately from one another.

According to one example of the above arrangement, the “proper-diet-plan” is provided to the user, so as to indicate a plurality of alternative foods that the user preferably takes as the staple food in accordance with his or her constitution, so as to indicate a plurality of alternative foods that the user preferably takes as the side dish in accordance with his or her constitution, and so as to indicate a plurality of alternative beverages that the user preferably takes in accordance with his or her constitution.

According to another arrangement of the “proper-diet-plan” in the present mode (19), the recipe of the proper diet is provided to the user so as to display on the screen a food and a beverage that the user preferably takes in accordance with his or her constitution, for each meal, or for all the meals in each day. In the case of practicing the above arrangement, a menu or a list of dished, as defined in accordance with the user's constitution may be provided to the user, each day, each week, or each month, for example.

The characteristic technologies set forth in the present mode (19) may be utilized independently of the characteristic technologies set forth in any one of the above modes (1) to (16), thereby constituting a system for supporting, by the use of a computer, in advising a proper-diet-plan suitable to a user of the system, irrespective of the content of the principle under which the user's constitution is determined.

(20) A system for determining a constitution and a condition, of an arbitrary user of the system, by the use of a computer, comprising:

the apparatus defined in any one of the above modes (1) to (16); and

an apparatus for determining the user's condition by the use of a computer with a screen, including:

(a) questions displaying means for displaying on the screen questions to be answered by the user, wherein the questions are constructed so as to be classified into a plurality of items used for determining the user's condition; and

(b) condition displaying means for determining, on the basis of data indicative of the user's answers to the questions displayed on the screen, and according to a predetermined determination rule, the user's condition as one of a predetermined plurality of types; and for displaying the determined condition on the screen.

Although it has been said that a human being's constitution ideally bears a medium-nature, even if his or her constitution bears a medium-nature, he or she is possibly in bad shape, or likely suffers sickness.

Behind that, the system according to the present mode (20) is operated, like the apparatus set forth in any one of the above modes (1) to (16), such that the user's constitution is determined, and the same user's condition, namely, his or her shape is determined, on the basis of the user's answers to the questions used for determining his or her condition, and according to a predetermined determination rule, as one of a predetermined plurality of types.

Consequently, this system would contribute to a capability of determining both the constitution and the condition of the same user, and a resulting capability of enabling the user to recognize not only his or her constitution but also his or her condition. As a result, this system would make it easier for the user to precisely assess his or her physical status.

(21) The system according to the above (20), wherein the plurality of items used in the apparatus defined in any one of the above modes (1) to (16) include a plurality kinds of symptoms to be commonly occurred on a human being when he or she is in bad shape or suffers sickness.

(22) A computer program to be executed by a computer for determining a constitution of an arbitrary user of the computer, by implementing a method comprising:

a rank selecting step of selecting, for each one of a plurality of items which are used for determination of the user's constitution, on the basis of data indicative of information with regard to the user himself or herself, at least one of a plurality of ranks which are used for quantitatively expressing a strength of a tendency of the user to show with regard to the each item; and

a constitution displaying step of calculating, for the each item, on the basis of a selection result provided by the rank selecting step, and according to a predetermined point allocation which defines how may points are allocated to each one of the plurality of ranks when selected, a score of the each rank; of summing, for the each rank, a plurality of scores obtained by the calculating with regard to all the plurality of items, thereby determining, on the basis of a distribution pattern of a plurality of sums respectively obtained by the summing for the plurality of ranks, wherein the distribution pattern reflects how a population consisting of the plurality of sums is scattered over a range of the plurality of ranks, and according to a predetermined determination rule, the user's constitution as one of a predetermined plurality of types; and of displaying the determined constitution on a screen of the computer.

The execution of this computer program would provide the same functions and results as the apparatus according to the above mode (1) would provide.

The “computer program” in the present mode (22) and the following modes may be interpreted to include not only a set of instructions to be executed by the computer such that the computer program may function, but also any files or data to be processed by the computer according to the set of instructions.

The “method” in the present mode (22) may be implemented by applying with necessary modifications an arrangement set forth in any one of the above modes (2) to (21).

(23) A computer-readable storage medium in which the computer program according to the above mode (22) has been stored.

The execution by a computer, of the computer program which has been stored in the computer-readable storage medium according to the present mode (23) would provide the same functions and results as the apparatus according to the above mode (1) would provide.

The “storage medium” in the present mode (23) may be realized in different types, including a magnetic recording medium, such as a floppy-disc, an optical recording medium, such as a CD and a CD-ROM, an optical-magnetic recording medium, such as an MO, an un-removable storage, such as a ROM, for example.

This interpretation will be adaptable to the following modes.

(24) A computer program to be executed by a computer for determining a constitution of an arbitrary user of the computer, by implementing a method comprising:

a questions displaying step of displaying on a screen of the computer questions which are to be answered by the user, wherein the questions are constructed, such that the questions are classified into a plurality of items which are used for determination of the user's constitution, and such that the questions bear, for each one of the plurality of items, a plurality of ranks which are used for quantitatively expressing a strength of a tendency of the user to show with regard to the each item, wherein at least one of the plurality of ranks is to be selected by the user for the each item; and

a constitution displaying step of selecting, for the each item, on the basis of data indicative of the user's answers to the questions displayed on the screen; of calculating, on the basis of a selection result obtained by the selecting, and according to a predetermined point allocation which defines how may points are allocated to each one of the plurality of ranks when selected, a score of the each rank; of summing, for the each rank, a plurality of scores obtained by the calculating with regard to all the plurality of items, thereby determining, on the basis of a distribution pattern of a plurality of sums respectively obtained by the summing for the plurality of ranks, wherein the distribution pattern reflects how a population consisting of the plurality of sums is scattered over a range of the plurality of ranks, and according to a predetermined determination rule, the user's constitution as one of a predetermined plurality of types; and of displaying the determined constitution on the screen.

The execution of this computer program would provide the same functions and results as the apparatus according to the above mode (4) would provide.

The “method” in the present mode (24) may be implemented by applying with necessary modifications an arrangement set forth in any one of the above modes (5) to (21).

(25) A computer-readable storage medium in which the computer program according to the above mode (24) has been stored.

The execution by a computer, of the computer program which has been stored in the computer-readable storage medium according to the present mode (25) would provide the same functions and results as the apparatus according to the above mode (4) would provide.

(26) The apparatus according to the above mode (1), wherein the data indicative of information with regard to the user himself or herself includes image data indicative of an image of at least one portion of a human body of the user, and the rank selecting means selects the at least one of the plurality of ranks, on the basis of the image data, without depending on the user's answers to questions for determining his or her constitution.

In general, a user is required less effort when taking his or her photograph and producing data indicative of the photograph than when answering questions.

Accordingly, the apparatus according to the present mode (26), because of its capability of making it unnecessary for the user to answer questions, would contribute to a determination of the user's constitution with his or her reduced effort.

(27) A method of providing a customer with a selected one of a plurality kinds of oral intakes including at least one of a food and a beverage, which selected one is compatible with the customer's constitution, comprising:

a constitution determining step of determining the customer's constitution, by operating, prior to selection from the plurality kinds of oral intakes, the apparatus set forth in any one of the above modes (1) to (16) or the above mode (26); and

an oral intake selecting step of selecting at least one of the plurality kinds of oral intakes which corresponds to the determined constitution, according to a predetermined selection rule.

The method would permit the customer to intake an oral intake suitable to his or her constitution, resulting in an improvement in his or her diet and lifestyle toward his or her promoted health.

The “oral intake” in the present mode (27) may be interpreted to include a generic food (containing a so-called health food); and may be interpreted to include such as a healthfully functional food containing a nutritiously functional food and a specified for health food, a supplementary food, etc.

The method according to the present mode (27) may be practiced to perform a business to provide customers with oral intakes at actual stores or establishments, or a business to sell oral intakes to customers in a mail order manner.

(28) The computer program according to the above mode (22), wherein the data indicative of information with regard to the user himself or herself includes image data indicative of an image of at least one portion of a human body of the user, and the rank selecting step is practiced to select the at least one of the plurality of ranks, on the basis of the image data, without depending on the user's answers to questions for determination his or her constitution.

As set forth previously, in general, a user is required less effort when taking his or her photograph and producing data indicative of the photograph than when answering questions.

Accordingly, the computer program according to the present mode (28), because of, its capability of making it unnecessary for the user to answer questions, would contribute to a determination of the user's constitution with his or her reduced effort.

### BRIEF DESCRIPTION OF THE DRAWINGS

The foregoing disclosure of the invention, as well as the following detailed description of best mode for carrying out the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 schematically illustrates a proper-diet-plan advice supporting system constructed according to a first embodiment of the present invention;

FIG. 2 is a block diagram schematically illustrating the construction of a client computer 10 indicated in FIG. 1;

FIG. 3 is a block diagram schematically illustrating the construction of a server computer 12 indicated in FIG. 1;

FIG. 4 is a block diagram illustrating a part of the functions of the server computer 12 indicated in FIG. 3;

FIG. 5 is a block diagram illustrating the remainder of the functions of the server computer 12 indicated in FIG. 3;

FIG. 6 is a flow chart schematically illustrating a main program stored in a program memory 60 indicated in FIG. 3;

FIG. 7 is a flow chart schematically illustrating, by the name of constitution determination program, the details of step S5 indicated in FIG. 6;

FIG. 8 illustrates with a screen image a first table for determining constitution, as displayed on a screen 42 as a result of the execution of step S31 indicated in FIG. 7;

FIG. 9 illustrates with a screen image a second table for determining constitution, as displayed on the screen 42 as a result of the execution of step S33 indicated in FIG. 7;

FIG. 10 illustrates with a table a point allocation required for the calculation in step S35 indicated in FIG. 7;

FIG. 11 illustrates ten types into which human beings' constitutions are classified in the constitution determination program indicated in FIG. 7;

FIG. 12 shows a plurality of graphs illustrating features of the ten types, respectively;

FIG. 13 illustrates with a table a rule for a point conversion in step S36 indicated in FIG. 7;

FIG. 14 illustrates with a table a relationship between distribution patterns of sums, distribution pattern numbers, and provisional types of constitutions, which relationship is utilized in the step S36 indicated in FIG. 7;

FIG. 15 illustrates with a table a relationship between per-class application numbers, distribution pattern numbers, and final types of constitutions, which relationship is utilized in step S38 indicated in FIG. 7;

FIG. 16 is a flow chart schematically illustrating, by the name of proper-diet-plan advice program, the details of step S6 indicated in FIG. 6;

FIG. 17 is a flow chart schematically illustrating, by the name of condition determination program, the details of step S7 indicated in FIG. 6;

FIG. 18 illustrates with a screen image a table for determining condition, as displayed on the screen 42 as a result of the execution of step S71 indicated in FIG. 17;

FIG. 19 is a flow chart schematically illustrating, by the name of obesity-related constitution determination program, the details of step S9 indicated in FIG. 6;

FIG. 20 illustrates with a screen image a table for determining obesity-related condition, as displayed on the screen 42 as a result of the execution of step S91 indicated in FIG. 19;

FIG. 21 illustrated with a table a point allocation required for the calculation in step S93 indicated in FIG. 19;

FIG. 22 illustrates with a table a relationship between distribution patterns of sums, distribution pattern numbers, and types of obesity-related constitutions, which relationship is utilized in step S94 indicated in FIG. 19;

FIG. 23 illustrates with a screen image a part of a first table for determining constitution, which table is utilized in a proper-diet-plan advice supporting system constructed according to a second embodiment of the present invention;

FIG. 24 illustrates with a screen image the remainder of the first table for determining constitution, which table is utilized in the second embodiment;

FIG. 25 is a block diagram schematically illustrating a server computer 200 in a constitution determining system constructed according to a third embodiment of the present invention;

FIG. 26 is a flow chart schematically illustrating a constitution determination program stored in a program memory 210 indicated in FIG. 25;

FIG. 27 is a flow chart schematically illustrating, by the name of pattern recognition routine, the details of step S202 indicated in FIG. 26;

FIG. 28 illustrates with a table a relationship between a plurality of items and a plurality of ranks in the third embodiment;

FIG. 29 is a front view schematically illustrating an image which is entered into and processed in the system according to the third embodiment, for determining a constitution of a user of the system, which image represents the user's face;

FIG. 30 is a perspective view illustrating a store in which a constitution-oriented oral-intake providing method constructed according to a fourth embodiment of the invention is practiced;

FIG. 31 is a block diagram schematically illustrating the construction of a constitution determining system 240 indicated in FIG. 30;

FIG. 32 is a flow chart schematically illustrating a series of procedures followed for each customer in the store indicated in FIG. 30;

FIG. 33 is a micrograph of a blood sample taken from a human being, which micrograph was taken for the purpose of showing that constitutions of human beings are classified as one of three basic types and at least one compound type;

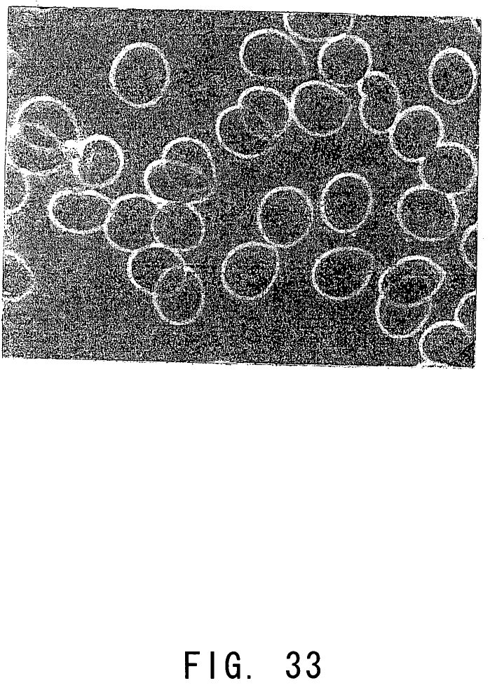

FIG. 34 is another micrograph of a blood sample taken from a human being;

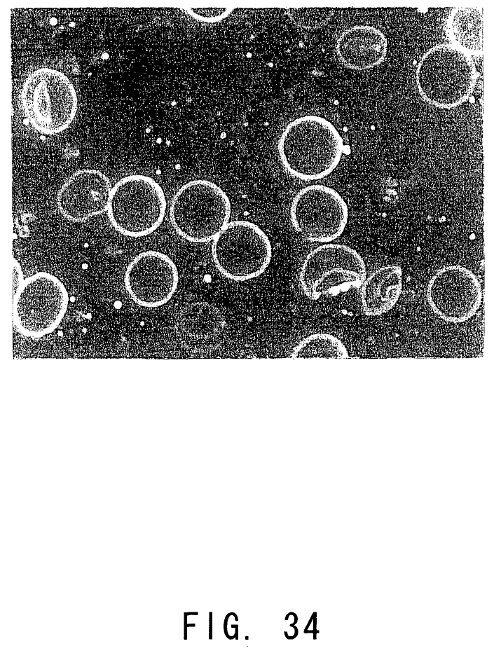

FIG. 35 is still another micrograph of a blood sample taken from a human being;

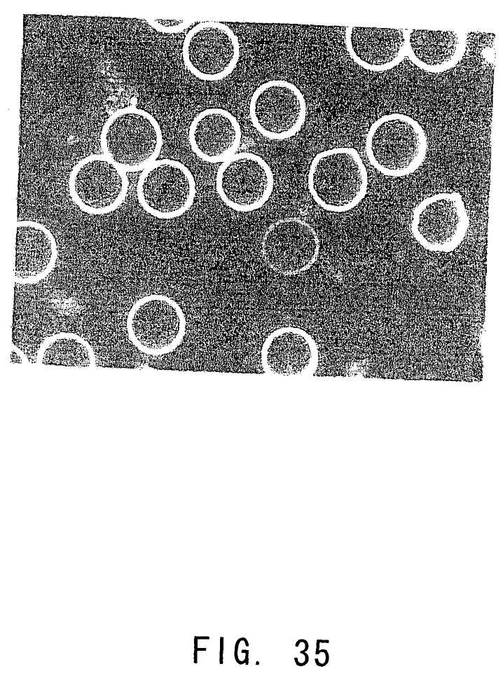

FIG. 36 is an additional micrograph of a blood sample taken from a human being;

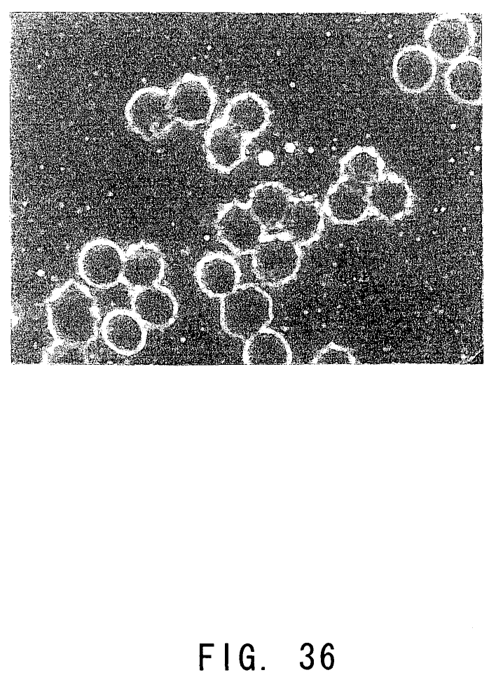

FIG. 37 is a still additional micrograph of a blood sample taken from a human being;

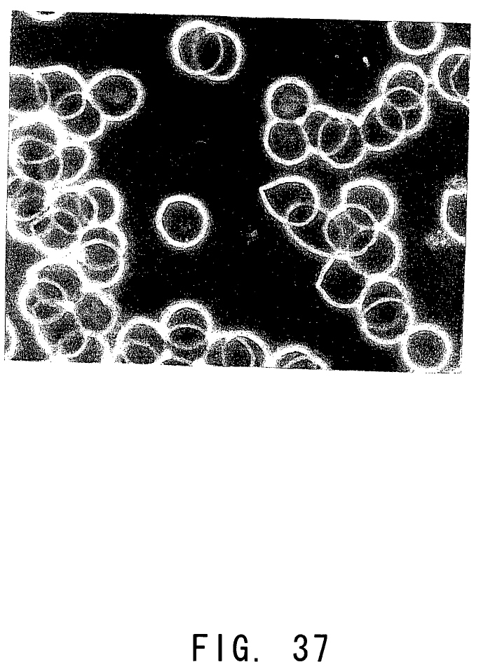

FIG. 38 is a further micrograph of a blood sample taken from a human being;

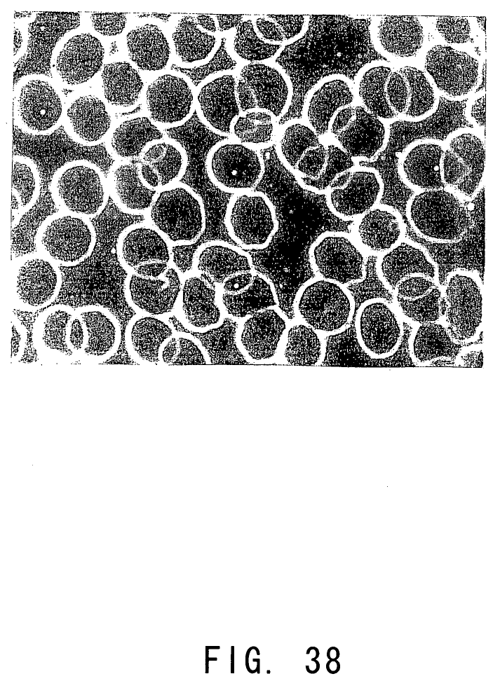

FIG. 39 is a still further micrograph of a blood sample taken from a human being;

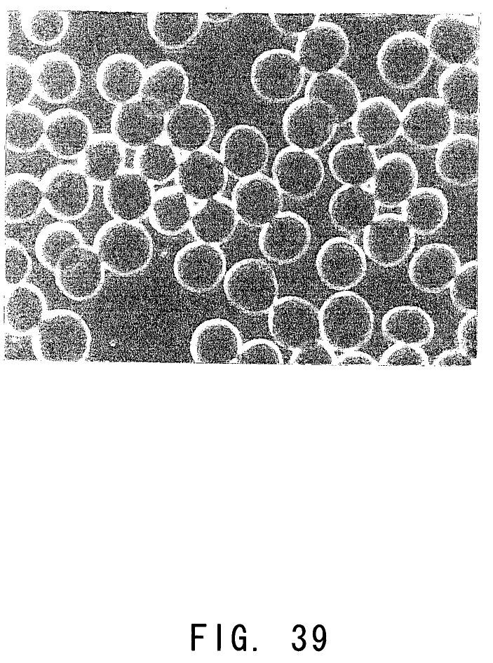

FIG. 40 is an additional micrograph of a blood sample taken from a human being;

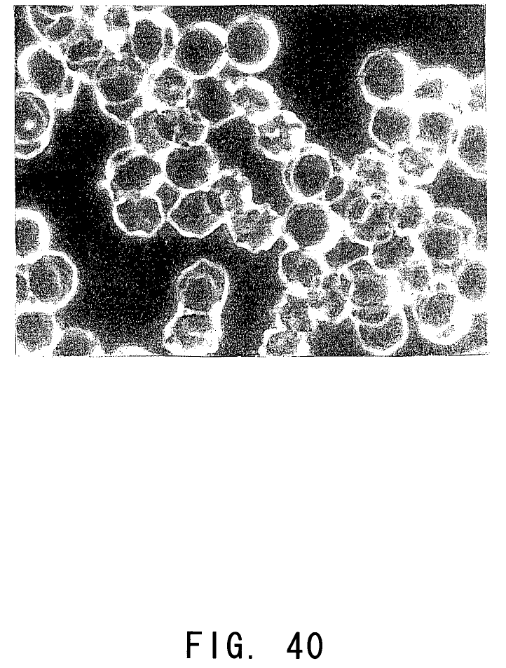

FIG. 41 is a still additional micrograph of a blood sample taken from a human being;

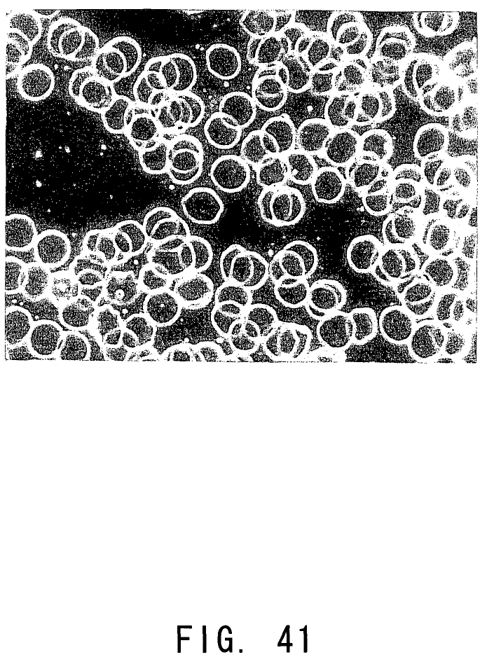

FIG. 42 is another micrograph of a blood sample taken from a human being;

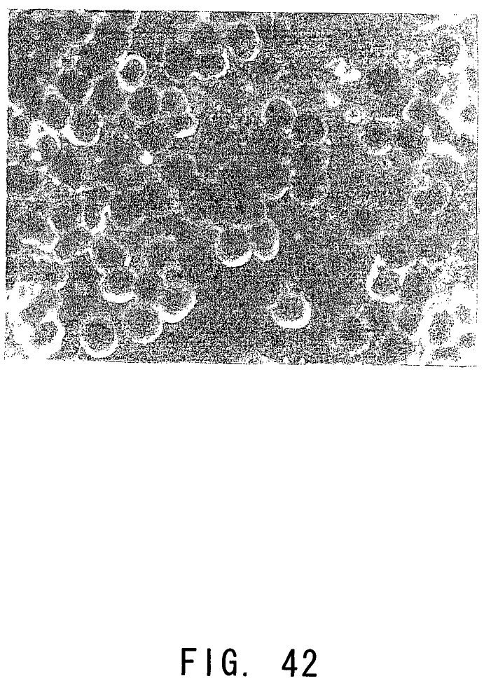

FIG. 43 is still another micrograph of a blood sample taken from a human being; and

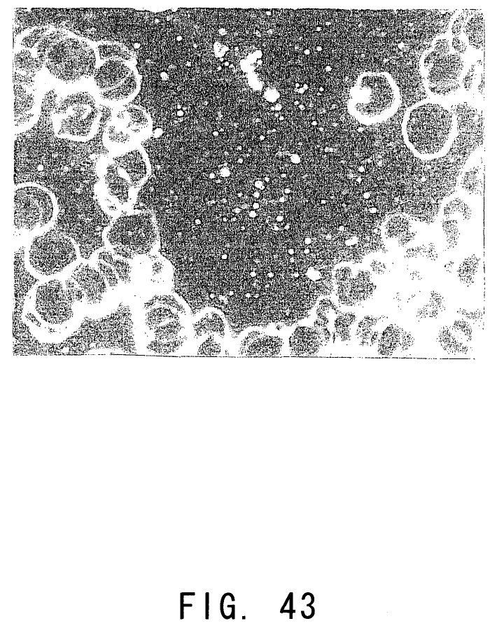

FIG. 44 is a further micrograph of a blood sample taken from a human being.

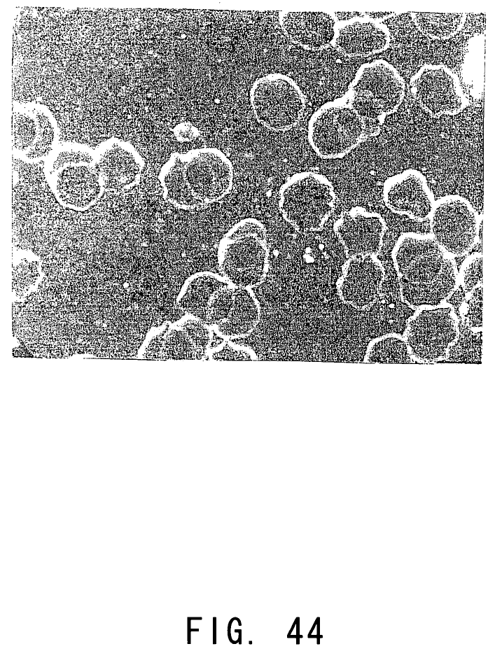

### BEST MODE FOR CARRYING OUT THE INVENTION

Several presently preferred embodiments of the invention will be described in detail by reference to the drawings in which like numerals are used to indicate like elements throughout.

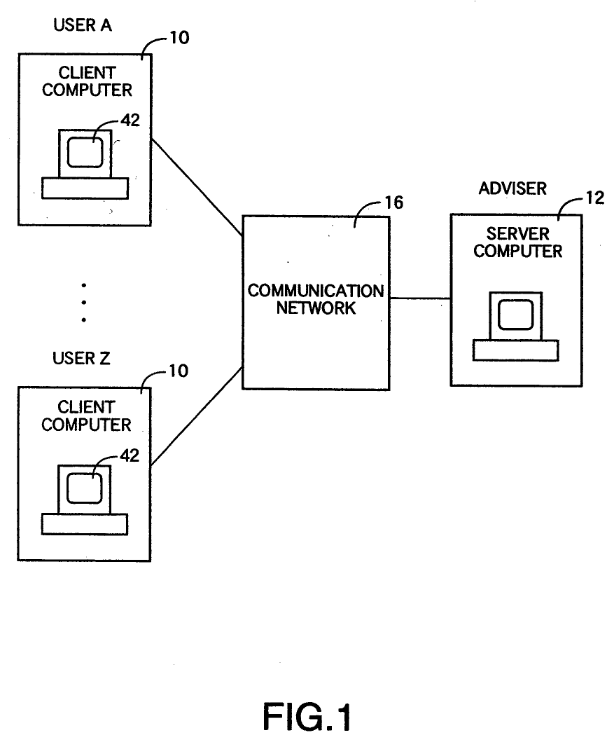

Referring now to FIG. 1, there is schematically illustrated with a block diagram the hardware resources of a proper-diet-plan advice supporting system (hereinafter referred to simply as “system”) constructed according to a first embodiment of a first aspect of the present invention.

This system includes a constitution determining apparatus constructed according to one embodiment of a second aspect of the present invention. This system further includes a constitution and condition determining apparatus constructed according to one embodiment of a third aspect of the present invention. This system still further includes a storage medium constructed according to one embodiment of a fourth aspect of the present invention.

As shown in FIG. 1, this system is configured such that a plurality of client computers 10 (only two representative client computers 10 being shown in FIG. 1) and a server computer 12 are connected with each other through a communication network 16. One example of the communication network 16 is the Internet.

These client computers 10 are used by a plurality of users each of who intends to seek advice regarding a proper-diet-plan. Each user can use each client computer 10, at home, or at a store associated with an adviser as described below, for example.

Alternately, the server computer 12 is used by the adviser who intends to provide the proper-diet-plan to a requesting user. The server computer 12 is installed at the store managed by the adviser, for example.

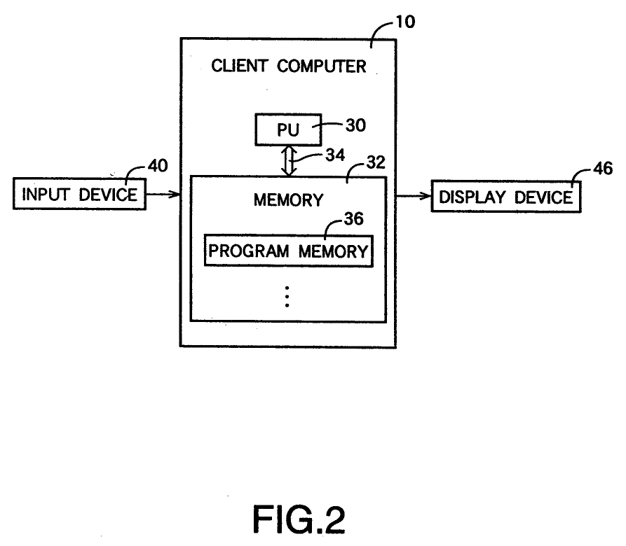

Referring next to FIG. 2, the client computer 10 is configured such that a processing unit (hereinafter referred to as “PU”) and a memory 32 are interconnected through a bus 34. The memory 32 is structured to include a storage medium, such as a ROM, a RAM, a magnetic disc, an optical disc, etc. The memory 32 contains a program memory 36 in which there has been stored various programs for achieving such as a transmission and reception function, a browsing function, etc.

The client computer 10 is connected with an input device 40 for letting the user to enter data into the client computer 10, and a display device 46 for displaying on a screen 42 as shown in FIG. 1, data outputted from the client computer 10.

One example of the input device 40 is structured to include such as a keyboard, a mouse functioning as a pointing device, and the like. One example of the display device 46 is in turn structured to include at least one of an LCD, a CRT, and the like.

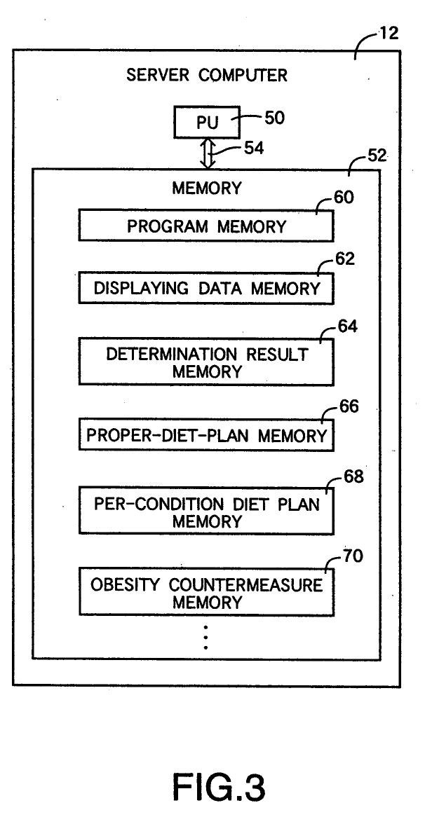

Referring next to FIG. 3, the server computer 12 is configured in the same manner as the client computer 10, such that a PU 50 and a memory 52 are interconnected through a bus 54. The memory 52 is structured, similarly with the memory 32, to include a storage medium, such as a ROM, a RAM, a magnetic disk, an optical disk, and the like.

The memory 52 contains a program memory 60 in which there have been stored various programs ranging from a main program as described below to programs for achieving a transmission and reception function, a browsing function, etc.

The memory 52 further includes a displaying data memory 62. The displaying data memory 62 is adapted to store displaying data which is sent to the client computer 10 for instructing it to display a corresponding image on the screen 42.

The memory 52 still further includes a determination result memory 64. The determination result memory 64 is adapted to store as a determination result a constitution (inclusive of an obesity-related constitution) and a condition of the user, both of which have been determined as a result of the execution of the main program.

The memory 52 additionally includes a proper-diet-plan memory 66. There have been stored in the proper-diet-plan memory 66 a plurality kinds of proper-diet-plans in association with respective constitutions with which those proper-diet-plans are compatible.

In the present embodiment, each proper-diet-plan is constructed to provide the user with a proper diet which is suitable to his or her constitution and which would contribute to the user's improved constitution toward a medium one, by indicating the recipe of the proper diet such that a staple food, a side dish, and a beverage or an oral liquid intake (including a Japanese soup (i.e., a miso soup), a western soup, for example), are displayed separately from one another.

The memory 52 still additionally include a per-condition diet plan memory 68. There have been stored in the per-condition diet plan memory 68 a plurality kinds of per-condition diet plans in association with respective constitutions with which those per-condition diet plans are compatible.

The user's condition is determined as a result of the execution of the main program, in the same manner as the user's constitution.

The memory 52 further includes an obesity countermeasure memory 70. There have been stored in the obesity countermeasure memory 70 a plurality kinds of obesity countermeasures (including diet plans or exercise plans for eliminating or preventing obesity) in association with respective obesity-related constitutions with which those obesity countermeasures are compatible.

The user's obesity-related constitution is determined as a result of the execution of the main program, in the same manner as the user's constitution and condition.

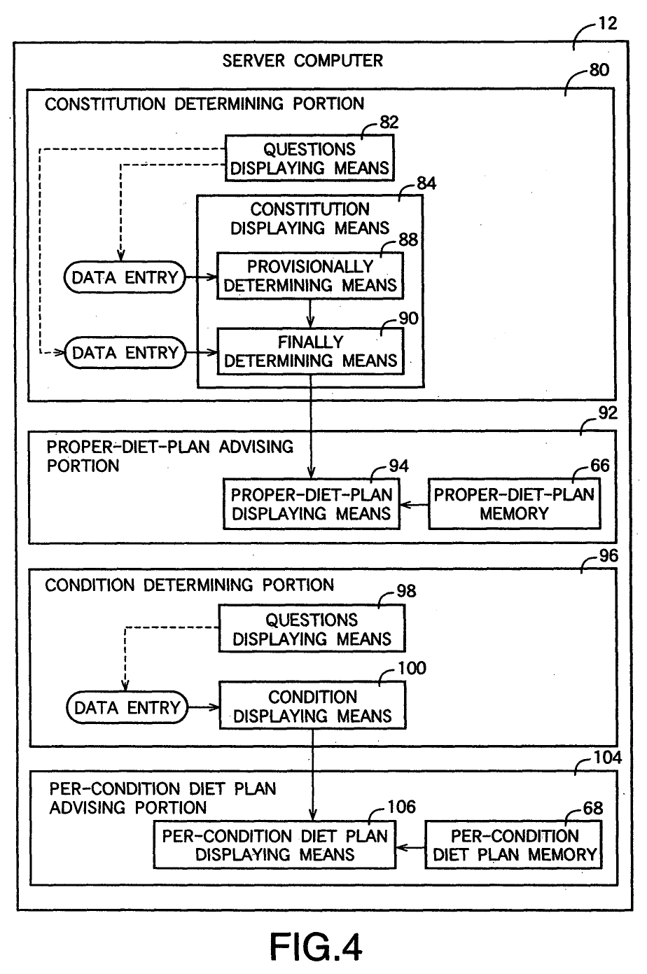

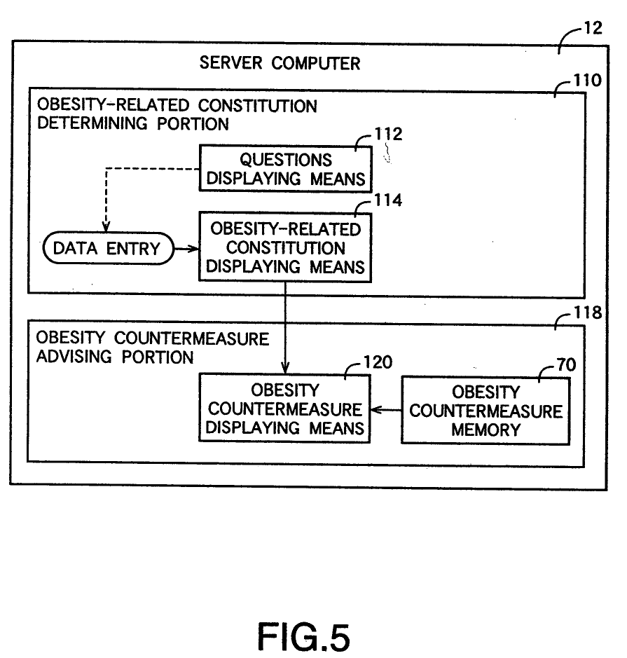

Referring next to FIGS. 4 and 5, there is schematically illustrated with a functional block diagram the construction of the server computer 12.

As shown in FIG. 4, the server computer 12 contains a constitution determining portion 80 for determining the user's constitution.

In the constitution determining portion 80, questions displaying means 82 transmits to the client computer 10 questions to be answered by the user for determination of his or her constitution, thereby instructing the client computer 10 to display on the screen 42 the thus transmitted questions using the browsing function. The questions displaying means 82 instructs the client computer 10 to display on the screen 42 the whole questions separately at two times.

It is added that, for the sake of a simplified description, there will be used the phrase “instructing the client computer 10 to display information on the screen 42” to mean “transmitting to the client computer 10 information to be displayed on the screen 42 of the client computer 10, thereby instructing the client computer 10 to display on the screen 42 the transmitted information using its browsing function.”

The constitution determining portion 80 further contains constitution displaying means 84 for determining the user's constitution, on the basis of his or her answers to the questions displayed on the screen 42, and for subsequently instructing the client computer 10 to display on the screen 42 the determination result of the user's constitution.

In the constitution displaying means 84, provisionally determining means 88 provisionally determines, on the basis of the user's answers to part of the whole questions which is displayed on the screen 42 at a first time, the user's constitution as at least one of a predetermined plurality of types.

In the constitution displaying means 84, further, finally determining means 90 finally determines the user's constitution by selecting one of the provisionally determined at least one constitution.

The server computer 12 further contains a proper-diet-plan advising portion 92 for advising for the user a proper-diet-plan corresponding to his or her finally determined constitution. In the proper-diet-plan advising portion 92, proper-diet-plan displaying means 94 retrieves in the proper-diet-plan memory 66 the proper-diet-plan suitable to the user's constitution, and instructs the client computer 10 to display on the screen 42 the retrieved proper-diet-plan.

The server computer 12 additionally contains a condition determining portion 96 for determining the user's condition, i.e., the user's shape. In the condition determining portion 96, questions displaying means 98 instructs the client computer 10 to display on the screen 42 the questions to be answered by the user for determining the user's condition.

In the condition determining portion 96, further, condition displaying means 100 determines, on the basis of the user's answers to the displayed questions, the user's condition as at least one of a predetermined plurality of types, and instructs the client computer 10 to display on the screen 42 the determined condition.

The server computer 12 still additionally contains a per-condition diet plan advising portion 104 to advise for the user a proper-diet-plan suitable to his or her thus determined condition. In the per-condition diet plan advising portion 104, per-condition diet plan displaying means 106 retrieves in the per-condition diet plan memory 68 the proper-diet-plan suitable to the user's condition, and instructs the client computer 10 to display on the screen 42 the retrieved proper-diet-plan.

The server computer 12 further contains an obesity-related constitution determining portion 110 for determining the user's obesity-related constitution. In the obesity-related constitution determining portion 110, questions displaying means 112 instructs the client computer 10 to display on the screen 42 the questions to be answered by the user for determining his or her obesity-related constitution.

In the obesity-related constitution determining portion 110, further, obesity-related constitution displaying means 114 determines, on the basis of the user's answers to the displayed questions, his or her obesity-related constitution as at least one of a predetermined plurality of types, and instructs the client computer 10 to display on the screen 42 the determined obesity-related constitution.

The server computer 10 still further contains an obesity countermeasure advising portion 118 to advise for the user a proper obesity-countermeasure suitable to the thus determined obesity-related constitution. In the obesity countermeasure advising portion 118, obesity countermeasure displaying means 120 retrieves in the previously described obesity countermeasure memory 70 the proper obesity-countermeasure corresponding to the user's obesity-related constitution, and instructs the client computer 10 to display on the screen 42 the retrieved obesity countermeasure.

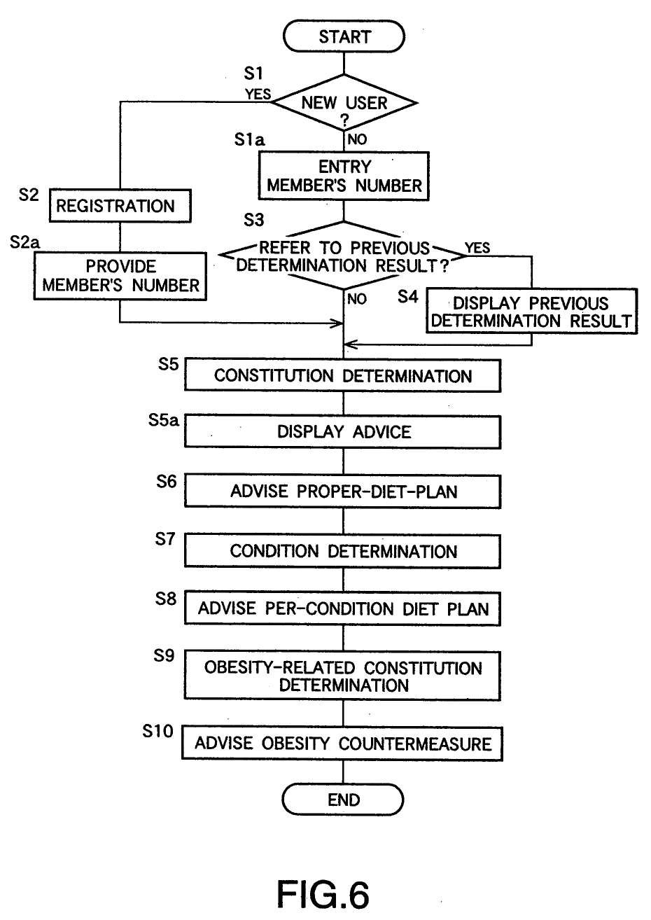

Referring next to FIG. 6, there is schematically illustrated with a flow chart the previously mentioned main program. The main program is executed by the server computer 12, in response to an arbitrary user's access to the server computer 12 through his or her client computer 10.

The execution of the main program is initiated with step S1 in which the determination of whether or not a current user is a new one to the server computer 12 is made.

In the present embodiment, the availability of the service to offer advise to users the proper-diet-plan is limited to the registered users, and to this end, step S1 is implemented to determine whether or not the current user is a new one, i.e., a non-registered one.

If the current user is a new one, the determination of step S becomes affirmative (YES), and then step S2 is implemented for registration of the current user to become one of the members who are authorized to receive the above service. Step S2 is implemented to prompt the current user to enter into the client computer 10 his or her name, address, birthdate, phone number, etc. Upon the completion, step S2a follows to provide a unique number to the current user. Step S2a is followed by step S5.

Alternatively, if the current user is not a new one, the determination of step S1 becomes negative (NO), and subsequently step S1a is implemented to prompt the current user to enter his or her number into his or her client computer 10.

Upon the current user's entry of his or her number, in step S3, there is displayed on the screen 42 the message indicating that the current user, if requests to refer to the previous determination result of his or her constitution, condition, and obesity-related constitution, is required to perform a specific operation on the client computer 10.

Step S3 is further implemented to determine whether or not the specific operation has been performed by the current user. If so, the determination of step S3 becomes affirmative, and then step S4 follows read out from the determination result memory 64 the previous determination result stored therein in association with the current user, and to display the previous determination result on the screen 42 of the client computer 10. Step S4 is followed by step S5.

On the other hand, if the current user does not request to refer to his or her previous determination result, the determination of step S3 becomes negative, and then the main program directly proceeds to step S5.

In step S5, the current user's constitution is determined. As will be readily understood from this, a portion of the server computer 12 which implements step S5 constitutes the previously mentioned constitution determining portion 80.

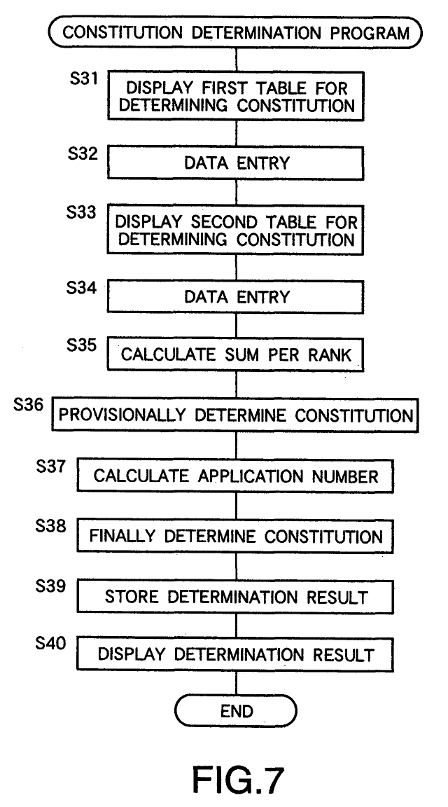

Referring next to FIG. 7, there is schematically illustrated with a flow chart the details of step S5 by the name of constitution determination program.

The constitution determination program is initiated with step S31 in which the displaying data indicative of the first table for determining constitution is read out from the displaying data memory 62, and the displaying data is transmitted to the client computer 10, whereby the first table for determining constitution is displayed on the screen 42 of the client computer 10.

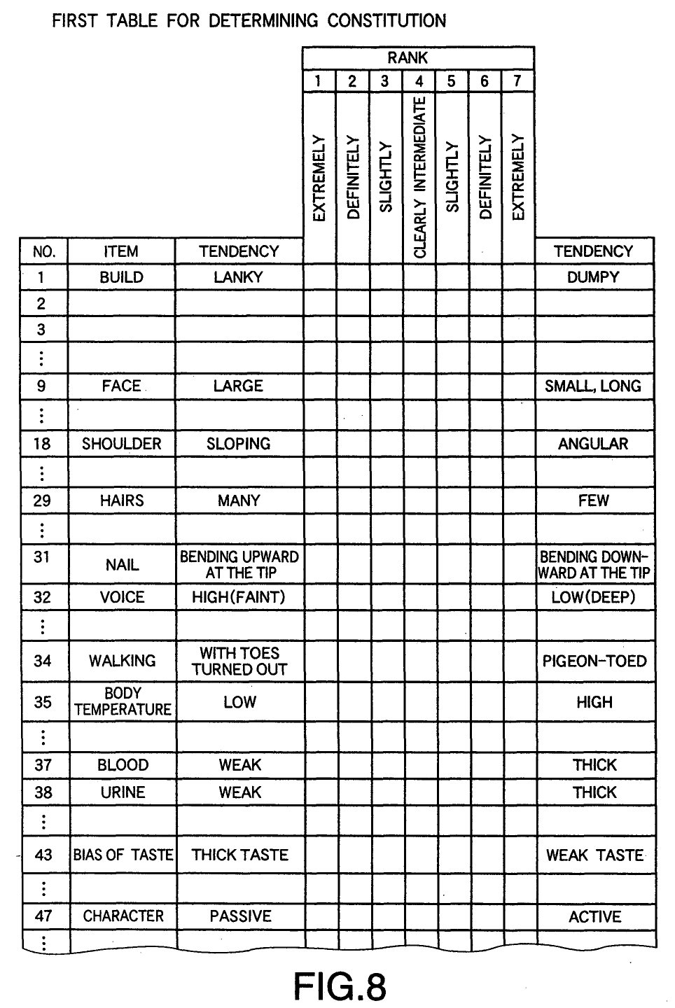

Referring next to FIG. 8, there is illustrated the first table for determining constitution. On the first table, the questions appear in association with a plurality of items.

The plurality of items include: features of a plurality of visible elements constituting the user's body; a feature of each one of a plurality of organs constituting the user's face; a feature of the user's hair; a feature of the user's voice; how the user walks; the user's body temperature; a condition of the user's blood; a level and a mode, of the user's blood pressure; a feature of the user's excreta and how often or how much the user excretes; the user's bias of taste; and the user's mental or spiritual feature.

On the first table for determining constitution, there appear a plurality of ranks for quantitatively expressing the strength of the tendency of the user to exhibit with regard to each one of the plurality of items. The user is required to select, per item, only one of the plurality of ranks which corresponds to himself or herself.

The number of the ranks is seven. The titles and the contents of the ranks are defined as follows:

Rank 1 (extremely): a strong-yin-rank to be selected per item when the user's constitution strongly shows a yin-nature

Rank 2 (definitely): a middle-yin-rank to be selected per item when the user's constitution considerably shows a yin-nature

Rank 3 (slightly): a weak-yin-rank to be selected per item when the user's constitution slightly shows a yin-nature

Rank 4 (clearly intermediate) a medium-rank to be selected per item when the user's constitution shows a medium-nature

Rank 5 (slightly): a weak-yang-rank to be selected per tem when the user's constitution slightly shows a yang-nature

Rank 6 (definitely): a middle-yang-rank to be selected per item when the user's constitution considerably shows a yang-nature

Rank 7 (extremely): a strong-yang-rank to be selected per item when the user's constitution strongly shows a yang-nature

Hereinafter, there will be described the relationship between the plurality of items indicated in FIG. 8 and the user's constitution, for selected ones of the plurality of items.

A human being's constitution is governed by an innate and an acquired factor. The innate factor originates from his or her parent's gene, resulting in appearance of a corresponding innate feature on the human being. Alternately, the acquired factor originates from foods that the human being takes or a circumstance under the human being lives, for example, resulting in appearance of a corresponding acquired feature on the human being.

The plurality of items indicated in FIG. 8 bear ones based on the innate feature, and one based on the acquired feature. One example of the former is “build” denoted at “item number 1” in FIG. 8, and one example of the latter is “bias of taste” denoted at “item number 43” in FIG. 8.

In reference to the above build, if a user's constitution is a yin-nature, the user's build tends to be lanky, due to the expanding nature featuring a yin-nature. Alternatively, if a user's constitution is a yang-nature, the user's build tends to be dumpy, due to the contracting nature featuring a yang-nature.

Alternately, in further reference to the above bias of taste, if a user's constitution is a yin-nature, the user's bias of taste tends to show that he or she likes thick taste better. Alternatively, if a user's constitution is a yang-nature, the user's bias of taste tends to show that he or she likes weak taste better.

By giving attention to the above relationships, the plurality of items indicated in FIG. 8 have been defined to contain ones based on the build and ones based on the bias of taste.

Following step S31 indicated in FIG. 7, in step S32, the current user enters data in association with the first table for determining constitution displayed on the screen 42 of the client computer 10. Specifically, the current user enters data indicative of one of the seven ranks which has been selected by the user per item, functioning as answer data indicative of the user's answers to the first table for determining constitution.

Subsequently, in step S33, there is read out from the displaying data memory 62 the displaying data for displaying the second table for determining constitution, and the displaying data is transmitted to the client computer 10, whereby the second table is displayed on the screen 42 of the client computer 10.

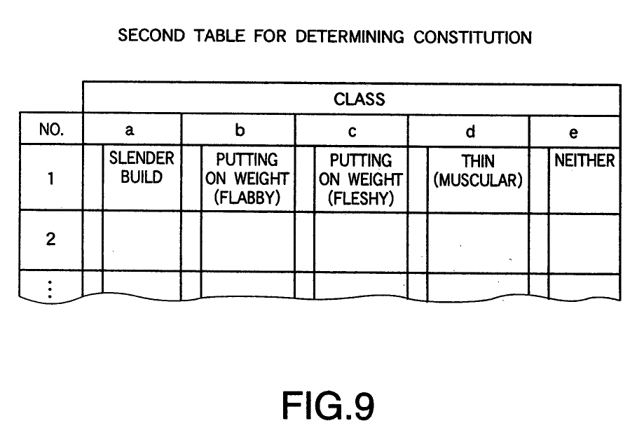

Referring next to FIG. 9, there is illustrated the second table for determining constitution. As will be readily understood from FIG. 9, there appear questions in association with a plurality of items on the second table, in the same manner as the first table described above. The second table further bears per item a plurality of classes for quantitatively expressing the strength of the tendency of the current user to exhibit with regard to each item.

The plurality of classes are formed as five classes which are arranged in the same manner as the seven ranks described above. The current user is required to select only one of the five classes which corresponds to himself or herself.

Afterward, in step S34 indicated in FIG. 7, the current user enters data in association with the second table for determining constitution displayed on the screen 42 of the client computer 10. Specifically, the current user enters data indicative of one of the five classes which has been selected by the user per item, functioning as answer data indicative of the user's answers to the second table for determining constitution.

Subsequently, in step S35, a score is calculated per rank, on the basis of the answer data which has been entered per item on the first table for determination constitution, and according to a predetermined point allocation rule defining how many points are to be allocated to each rank when selected.

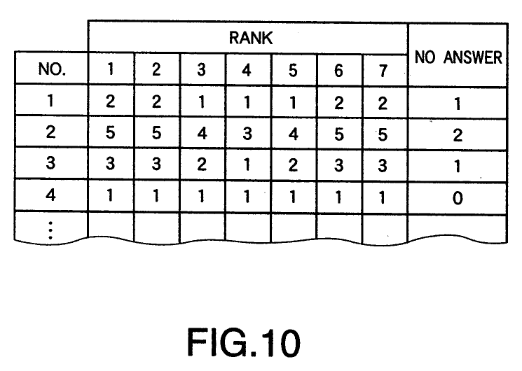

Referring next to FIG. 10, there is illustrated with a table one example of the point allocation rule. In this example, there is represented with points the extent to which the user's no answer for each item influences the whole of the constitution determination result. The intended application of the no-answer-influence-points will be described below.

In step S35, further, a plurality of scores which have been calculated respective ranks for all the items are summed per rank. As a result, seven sums have been obtained for the seven ranks, respectively.

Following that, in step S36, the current user's constitution is provisionally determined as at least one of the plurality of types described previously, on the basis of the seven sums obtained for respective seven ranks.

Hereinafter, the plurality of types will be described.

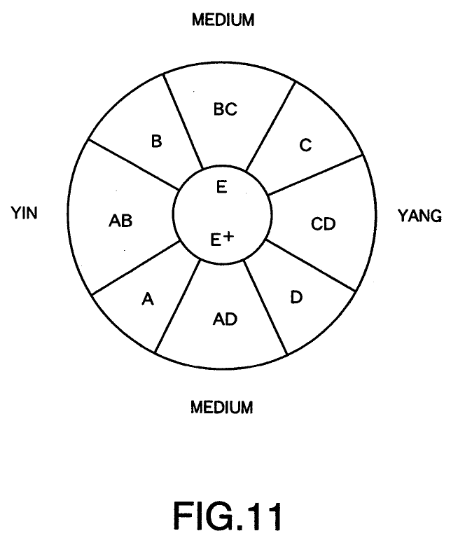

As shown in FIG. 11, the number of the types is ten, consisting of five basic or independent types, each of which has been established independently of other basic types, and five compound type, each of which has been established by combining two of the five basic types. These ten types are defined as follows:

(1) Basic Types

Type A: showing that a user's constitution strongly bears a yin-nature

Type B: showing that a user's constitution slightly bears a yin-nature

Type C: showing that a user's constitution slightly bears a yang-nature

Type D: showing that a user's constitution strongly bears a yang-nature

Type E: showing that a user's constitution bears a medium-nature

(2) Compound Types

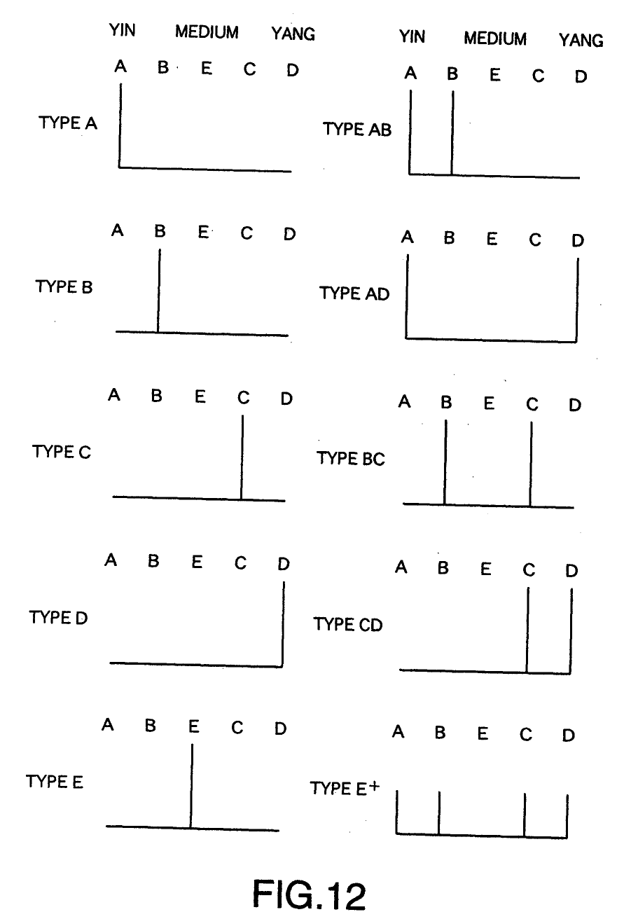

Type AD: as schematically shown in FIG. 12, a component of type A and a component of type D coexist in a user's constitution, to approximately the same extent as each other, and more distinguishably than possible components of other basic types exist

Type AB: as schematically shown in FIG. 12, a component of type A and a component of type B coexist in a user's constitution, to approximately the same extent as each other, and more distinguishably than possible components of other basic types exist

Type BC: as schematically shown in FIG. 12, a component of type B and a component of type C coexist in a user's constitution, to approximately the same extent as each other, and more distinguishably than possible components of other basic types exist

Type CD: as schematically shown in FIG. 12, a component of type C and a component of type D coexist in a user's constitution, to approximately the same extent as each other, and more distinguishably than possible components of other basic types exist

Type E+: as schematically shown in FIG. 12, a component of type A, a component of type B, a component of type C, and a component of type D coexist in a user's constitution, to approximately the same extent as one another

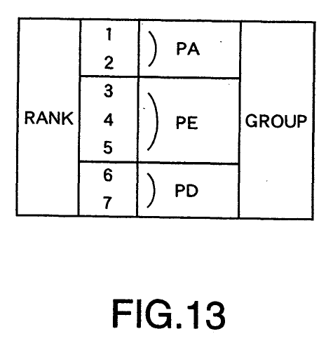

Described in detail, in step S36 indicated in FIG. 7, first of all, the above seven sums corresponding to the respective seven ranks are converted into scores for three groups. Described in more detail, as schematically shown in FIG. 13, the total of the sums of ranks 1 and 2 is converted into a score of group PA, the total of the sums of ranks 3 to is converted into a score of group PE, and the total of the sums of ranks 6 and 7 is converted into a score of group PD.

In step S36, further, the current distribution pattern of the scores for those three groups is determined as one of predetermined twelve classified distribution patterns.

It is added that, if the current distribution pattern has been determined as the fourth classified distribution pattern described below, it is found that the number of ones of the plurality of items included in the aforementioned first table for determining constitution, which ones have not been answered by the current user, is deficient to adequately precisely determine the current user's constitution, and accordingly the screen 42 is operated to prompt the current user to restart his or her answer to the first table. The above number may be calculated by allowing for the significance of each item.

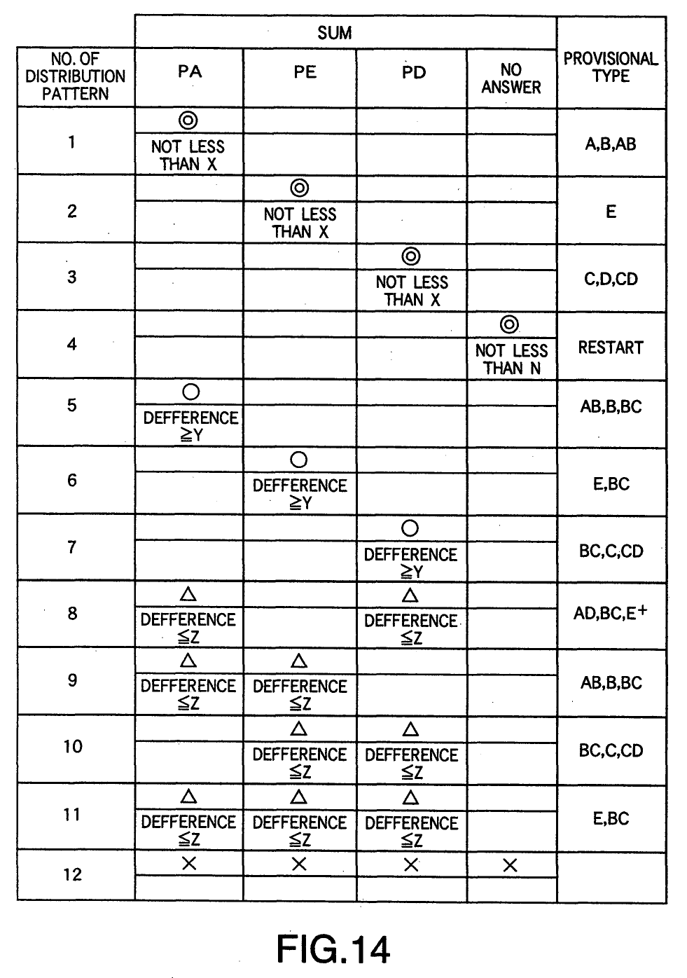

Hereinafter, those twelve classified distribution patterns will be described by referring to FIG. 14.

First Classified Distribution Pattern: showing that the score of group PA is the largest of all the three groups, and that it is not less than a set value X, that is, eventually showing that a population consisting of all the scores is intensively concentrated at group PA

Second Classified Distribution Pattern: showing that the score of group PE is the largest of all the three groups, and that it is not less than the set value X, that is, eventually showing that a population consisting of all the scores is intensively concentrated at group PE

Third Classified Distribution Pattern: showing that the score of group PD is the largest of all the three groups, and that it is not less than the set value X, that is, eventually showing that a population consisting of all the scores is intensively concentrated at group PD

Fourth Classified Distribution Pattern: showing that the aforementioned no-answer-influence-points is larger than any other scores for the three groups, and that it differs by not less than a set value N from the largest score of all the three groups

Fifth Classified Distribution Pattern: showing that the score of group PA is the largest of all the three groups, that it is less than the set value X, and that it differs by not less than a set value Y from the second largest score of all the three groups, that is, eventually showing that a population consisting of all the scores is slightly intensively concentrated at group PA

Sixth Classified Distribution Pattern: showing that the score of group PE is the largest of all the three groups, that it is less than the set value X, and that it differs by not less than the set value Y from the second largest score of all the three groups, that is, eventually showing that a population consisting of all the scores is slightly intensively concentrated at group PE Seventh Classified Distribution Pattern: showing that the score of group PD is the largest of all the three groups, that it is less than the set value X, and that it differs by not less than the set value Y from the second largest score of all the three groups, that is, eventually showing that a population consisting of all the scores is slightly intensively concentrated at group PD

Eighth Classified Distribution Pattern: showing that the score of group PA or PD is the largest all the three groups, that the score of group PD or PA is the second largest of all the three groups, and that the difference between those two scores is not more than a set value Z, that is, eventually showing that a population consisting of all the scores is scattered at groups PA and PD

Ninth Classified Distribution Pattern: showing that the score of group PA or PE is the largest all the three groups, that the score of group PE or PA is the second largest of all the three groups, and that the difference between those two scores is not more than the set value Z, that is, eventually showing that a population consisting of all the scores is scattered at groups PA and PE

Tenth Classified Distribution Pattern: showing that the score of group PE or PD is the largest all the three groups, that the score of group PD or PE is the second largest of all the three groups, and that the difference between those two scores is not more than the set value Z, that is, eventually showing that a population consisting of all the scores is scattered at groups PE and PD

Eleventh Classified Distribution Pattern: showing that the difference between the largest score and the second largest score of all the three groups is not more than the set value Z, and that the difference between the second largest score and the third largest score of all the three groups is neither more than the set value Z, that is, eventually showing that a population consisting of all the scores is scattered at the three groups

Twelfth Classified Distribution Pattern: showing that the score of every and each group is zero

The plurality of classified distribution patterns described above have been associated with provisional types of constitutions. One example of the relationship between those classified distribution patterns and the aforementioned provisional types is illustrated in FIG. 14.

Thus, the execution of step S35 indicated in FIG. 7 is terminated, and thereafter, in step S37, the number (hereinafter referred to as “application number”) of ones of the plurality of classes for all the items, which ones have been selected by the current, is calculated per class, on the basis of the answer data which has been entered by the current user per item for the second table for determining constitution.

In step S37, further, the current user's constitution is determined as one of the aforementioned predetermined plurality of final types, which one corresponds to a combination of the thus calculated application numbers for the respective classes, and the number of one of the plurality of classified distribution patterns, which one has been determined in step S36.

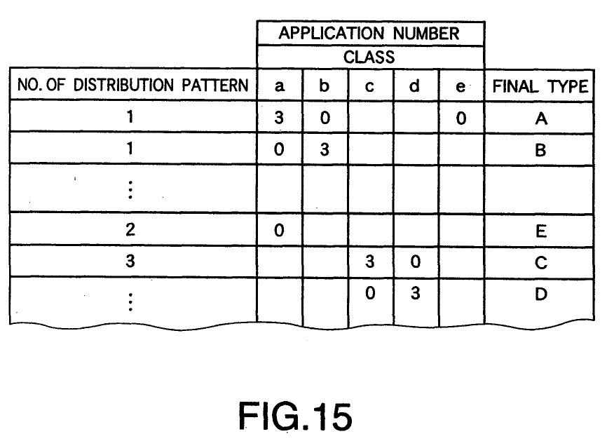

In FIG. 15, there is illustrated one example of the relationship between the classified distribution patterns, the application numbers, and the final types. For each classified distribution pattern, its final type is defined as one of the provisional types corresponding to the each classified distribution pattern.

Following that, in step S39 indicated in FIG. 7, data for identifying the determined final type is stored in the determination result memory 64 in association with the identity of the current user. Subsequently, in step S40, the determined final type is displayed on the screen 42 of the client computer 10 used by the current user.

Thus, one cycle of the execution of the constitution determination program, namely, one cycle of the execution of step S5 indicated in FIG. 6 is terminated.

As will be readily understood from the foregoing description, the questions displaying means 82 is constructed by a portion of the server computer 12 which implements steps S31 and S33 indicated in FIG. 7. The provisionally determining means 88 is constructed by a portion of the server computer 12 which implements steps S32, S35, and S36. The finally determining means 90 is constructed by a portion of the server computer 12 which implements steps S34, S37, and S38. The constitution determining means 84 is constructed by a combination of the provisionally determining means 88, the finally determining means 90, and a portion of the server computer 12 which implements steps S39 and S40.

Following step S5 indicated in FIG. 6, in step S5a, only when the current user has requested to refer to his or her previous determination result, the advice useful for an improvement in the user's constitution is displayed on the screen 42, on the basis of a comparison between the current determination result and the previous one concerning his or her constitution.

For example, when the current determination result is more close to a medium-nature than the previous determination result, there is displayed on the screen 42 the message meaning that the current user's current diet therapy is proper. On the other hand, when the current determination result is further away from a medium-nature than the previous determination result, there is displayed on the screen 42 the message meaning that the current user's current diet therapy is improper. Data for displaying those messages have been stored in the displaying data memory 62.

Afterward, in step S6 indicated in FIG. 6, some advice on the proper-diet-plan suitable to the determined constitution is provided to the current user.

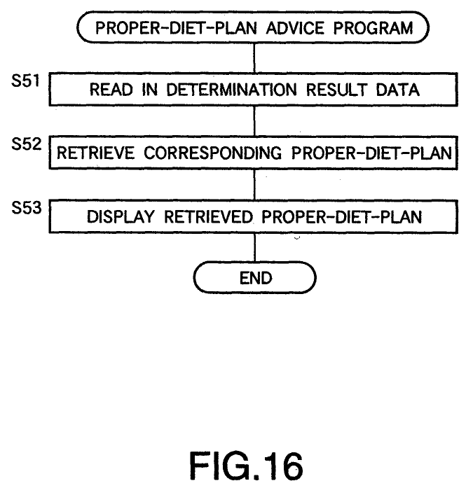

Referring next to FIG. 16, there is schematically illustrated with a flow chart the details of step S6 by the name of proper-diet-plan advice program.

The proper-diet-plan advice program is initiated with step S51 in which the determination result data indicative of the current user's newest determination result is read in from the determination result memory 64. Subsequently, in step S52, there is retrieved in the proper-diet-plan memory 66 the proper-diet-plan corresponding to the current user's constitution, i.e., the determination result which is represented by the current determination result data.

Following that, in step S53, the retrieved proper-diet-plan is displayed on the screen 42 of the client computer 10 used by the current user.

Thus, one cycle of the execution of the proper-diet-plan advice program, namely, one cycle of the execution of step S6 indicated in FIG. 6.

As will be evident from that, a portion of the server computer 12 which implements step S6 constitutes the proper-diet-plan displaying means 94.

Thereafter, in step 7 indicated in FIG. 6, the current user's condition is determined.

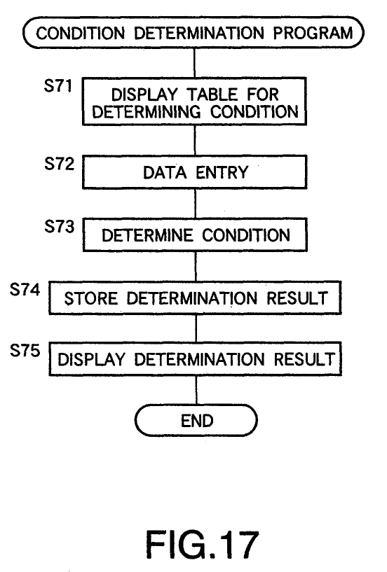

Referring next to FIG. 17, there is schematically illustrated with a flow chart the details of step S7 by the name of condition determination program.

The condition determination program is initiated with step S71 in which the displaying data for displaying the table for determining condition is read out from the displaying data memory 62, and then it is transmitted to the client computer 10, whereby the table for determining condition is displayed on the screen 42 of the client computer 10.

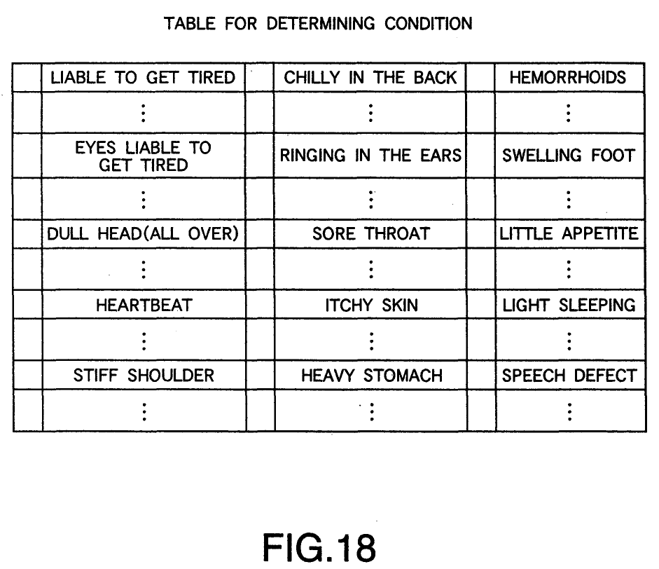

Referring next to FIG. 18, there is illustrated the table for determining condition. As will be apparent from FIG. 18, the table for determining condition bears questions with regard to a plurality of items. These items indicate a plurality of symptoms which commonly occur on a human being when he or she is in bad shape or suffers sickness.

Those symptoms include ones to be occurred on a specific portion of a human being, such as the whole body, the eyes, the head, the temple, the heart, the lungs, the shoulders, the back, the legs, the foot, the arms, the ears, the bronchi, the throat, the lip, the mucous of the nose, the nose, the palms, the fingertips, the skin, the liver, the abdomen, the stomach, the intestine, the bottom, the mouth, the brain, etc.

Following step S71, in step S72 indicated in FIG. 17, the current user enters data for the table for determining condition, which table has been displayed on the screen 42 of the client computer 10. More precisely, the current user enters data indicative of which one of the plurality of items he or she has selected, as the answer data indicative of the user's answers to the table for determining condition.

Subsequently, in step S73, the current user's condition is determined, on the basis of the thus entered answer data, and according to a predetermined relationship between a plurality kinds of answers presupposed for the questions appearing on the table for determining condition, and a plurality kinds of conditions presupposed for human beings.

Following that, in step S74, the determination result obtained by step S73 is stored in the determination result memory 64. Thereafter, in step S75, the determination result is displayed on the screen 42 of the client computer 10 used by the current user.

Thus, one cycle of the execution of the condition determination program, namely, one cycle of the execution of step S7 indicated in FIG. 6 is terminated.

As will be understood from the above description, a portion of the server computer 12 which implements step S7 constitutes the condition determining portion 96, a portion of the server computer 12 which implements step S71 constitutes the questions displaying means 98, and a portion of the server computer 12 which implements steps S72 to S75 constitutes the condition displaying means 100.

Following step S7, in step S8 indicated in FIG. 6, there is provided to the current user some advice on the per-condition diet plan suitable to his or her condition which has been determined by step S7.

Described particularly, in the same manner as the proper-diet-plan advice program indicated in FIG. 16, the per-condition diet plan suitable to the current user's condition is retrieved in the per-condition diet plan memory 68, and then the retrieved per-condition diet plan is displayed on the screen 42 of the client computer 10 used by the current user.

As will be readily derived from that, a portion of the server computer 12 which implements step S8 constitutes the per-condition diet plan displaying means 106.

Following step S8, in step S9 indicated in FIG. 6, the current user's obesity-related constitution is determined. As will be readily derived from that, a portion of the server computer 12 which implements step S9 constitutes the obesity-related constitution determining portion 110.

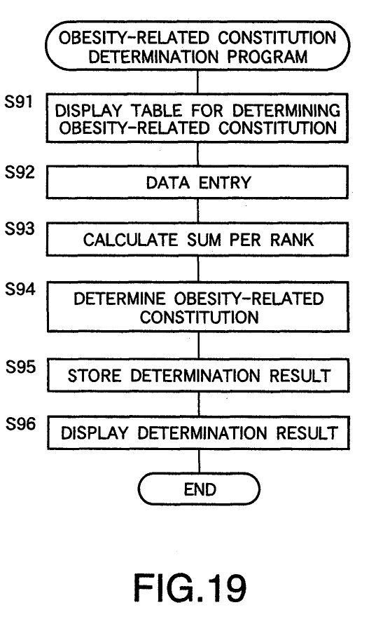

Referring next to FIG. 19, there is schematically illustrated with a flow chart the details of step S9 by the name of obesity-related constitution determination program.

The obesity-related constitution determination program is initiated with step S91 in which the displaying data for displaying the table for determining obesity-related constitution is read out from the displaying data memory 62, and then it is transmitted to the client computer 10, whereby the table for determining obesity-related constitution is displayed on the screen 42 of the client computer 10.

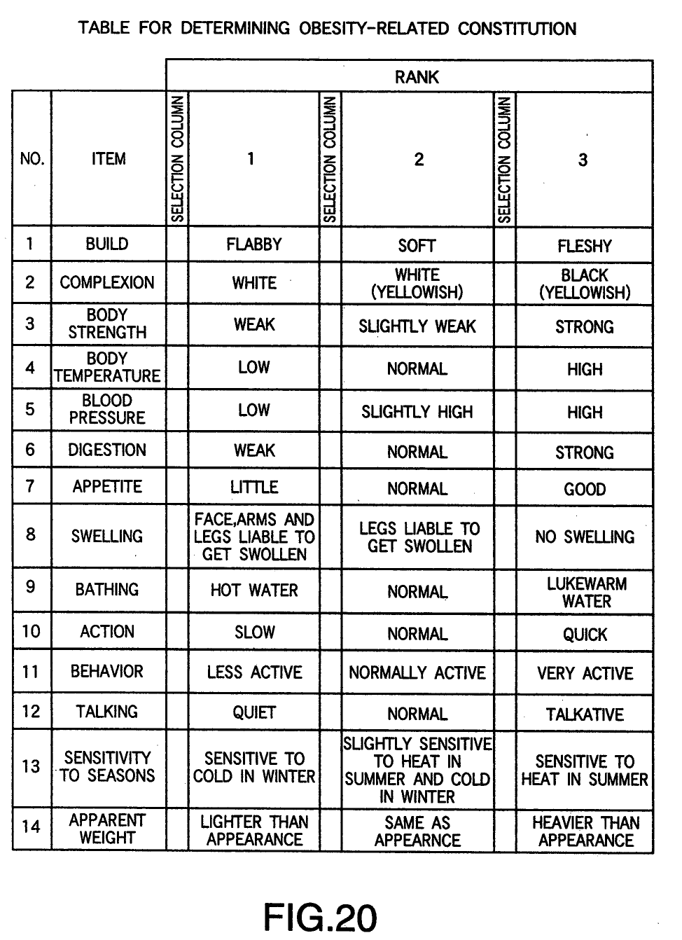

Referring next to FIG. 20, there is illustrated the table for determining obesity-related constitution. As will be clearly derived from FIG. 20, the table for determining obesity-related constitution bears questions in association with a plurality of items. These items include: a user's build; a user's complexion; a user's body strength; a user's body temperature; a user's blood pressure; a user's condition of the stomach and intestine; a user's appetite; a user's proneness to get swollen; a user's bias of the water temperature in bath; a user's quickness in movement; a user's activeness in behavior; a user being talkative or quiet; a user's adaptability to varied seasons; and a user's apparent weight.

The table for determining obesity-related constitution further bears per item a plurality of ranks for quantitatively expressing the strength of the tendency of the user to exhibit with regard to each item. The user is required to select per item only one of the plurality of ranks which corresponds to himself or herself.

The number of the ranks is three. The titles and the contents of these ranks are as follows:

Rank 1: a yin-rank to be selected per item when a user's constitution is yin-natured

Rank 2: a medium-rank to be selected per item when a user's constitution is medium-natured

Rank 3: a yang-rank to be selected per item when a user's constitution is yang-natured

Following step S91, in step S92 indicated in FIG. 19, the current user enters data for the table for determining obesity-related constitution, which table has been displayed on the screen 42 of the client computer 10. Described more specifically, the current user enters data indicative of which one of those three ranks which the current user has selected per item, as answer data indicative of the current user's answers to the table for determining obesity-related constitution.

Subsequently, in step S93, a score is calculated per rank, on the basis of the answer data which has been entered per item for the table for determination obesity-related constitution, and according to a predetermined point allocation rule defining how many points are to be allocated to each rank when selected.

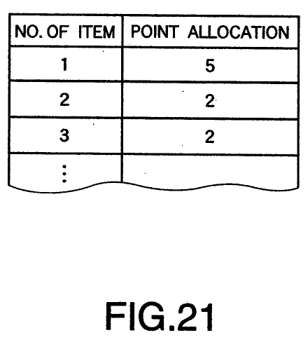

Referring next to FIG. 21, there is illustrated with a table one example of the point allocation rule. In this example, points are evenly allocated to every rank per item.

In step S93, further, a plurality of scores which have been calculated per rank for all the items are summed per rank. As a result, three sums have been obtained for the three ranks, respectively.

Following that, in step S94, the current user's obesity-related constitution is determined as at least one of a plurality of types, on the basis of the three sums obtained for respective three ranks.

Hereinafter, the plurality of types will be described.

The number of the plurality of types is six, consisting of five basic types and three compound types. These six types are defined as follows:

(2) Basic Types

Type OA: showing that a user's obesity-related constitution is yin-natured

Type OB: showing that a user's obesity-related constitution is medium-natured

Type OC: showing that a user's obesity-related constitution is yang-natured

(2) Compound Types

Type OAB: showing that a component of type OA and a component of type OB coexist in a user's constitution, to approximately the same extent as each other, and more distinguishably than a possible component of other basic type exists

Type OBC: showing that a component of type OB and a component of type CC coexist in a user's constitution, to approximately the same extent as each other, and more distinguishably than a possible component of other basic type exists

Type OAC: showing that a component of type OA and a component of type OC coexist in a user's constitution, to approximately the same extent as each other, and more distinguishably than a possible component of other basic type exists

Described in detail, in step S94 indicated in FIG. 19, the current distribution pattern of the three sums of the three ranks is qualified as one of predetermined six classified distribution patterns.

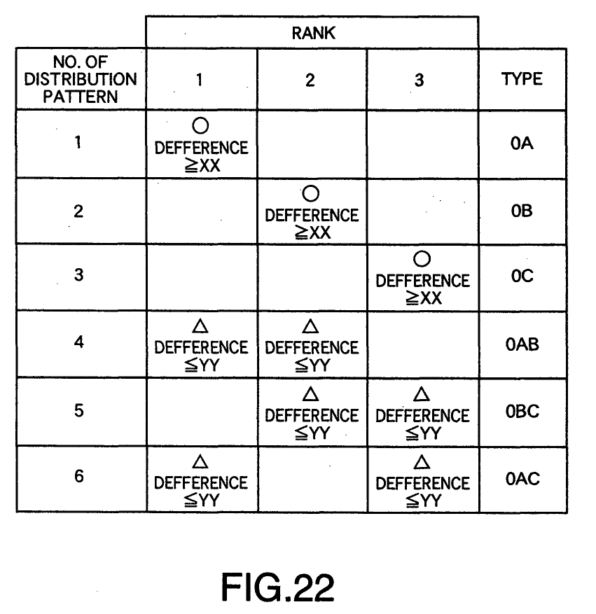

Hereinafter, those six classified distribution patterns will be described by referring to FIG. 22.

First Classified Distribution Pattern: showing that the sum of rank 1 is the largest of all the three ranks, and that it differs by not less than a set value XX from the second largest of all the three ranks, that is, eventually showing that a population consisting of all the sums is intensively concentrated at rank 1

Second Classified Distribution Pattern: showing that the sum of rank 2 is the largest of all the three ranks, and that it differs by not less than the set value XX from the second largest of all the three ranks, that is, eventually showing that a population consisting of all the sums is intensively concentrated at rank 2

Third Classified Distribution Pattern: showing that the sum of rank 3 is the largest of all the three ranks, and that it differs by not less than the set value XX from the second largest of all the three ranks, that is, eventually showing that a population consisting of all the sums is intensively concentrated at rank 3

Fourth Classified Distribution Pattern: showing that the sum of rank 1 or 2 is the largest of all the three ranks, that the sum of rank 2 or 1 is the second largest of all the three ranks, and that the difference between those two sums is not more than a set value YY, that is, eventually showing that a population consisting of all the sums is scattered at ranks 1 and 2

Fifth Classified Distribution Pattern: showing that the sum of rank 2 or 3 is the largest of all the three ranks, that the sum of rank 3 or 2 is the second largest of all the three ranks, and that the difference between those two sums is not more than the set value YY, that is, eventually showing that a population consisting of all the sums is scattered at ranks 2 and 3

Sixth Classified Distribution Pattern: showing that the sum of rank 1 or 3 is the largest of all the three ranks, that the sum of rank 3 or 1 is the second largest of all the three ranks, and that the difference between those two sums is not more than the set value YY, that is, eventually showing that a population consisting of all the sums is scattered at ranks 1 and 3

The plurality of classified distribution patterns described above have been associated with the types of obesity-related constitutions. One example of the relationship between those classified distribution patterns and those types is illustrated in FIG. 22.

In step S94 indicated in FIG. 19, after the current distribution pattern is determined as to which one of the six classified distribution patterns the current distribution pattern is qualified as, the current user's obesity-related constitution is determined as one of the plurality types which corresponds to the qualified classified-distribution-pattern.

Subsequently, in step S95, the determination result obtained by step S94 is stored in the determination result memory 64. Thereafter, in step S96, the determination result is displayed on the screen 42 of the client computer 10 used by the current user.

Thus, one cycle of the execution of the obesity-related constitution determination program, namely, one cycle of the execution of step S9 indicated in FIG. 6 is terminated.

As will be readily derived from the foregoing, a portion of the server computer 12 which implements step S91 constitutes the questions displaying means 112, and a portion of the server computer 12 which implements steps S92 to S96 constitutes the obesity-related constitution determining means 114.

Following that, in step S10 indicated in FIG. 6, there is provided to the current user some advice of the obesity countermeasure suitable to his or her obesity-related constitution which has been determined by step S9.

Described particularly, in the same manner as the proper-diet-plan advice program indicated in FIG. 16, the obesity countermeasure suitable to the current user's obesity-related constitution is retrieved in the obesity countermeasure memory 70, and then the retrieved obesity-countermeasure is displayed on the screen 42 of the client computer 10 used by the current user.

As will be readily derived from that, a portion of the server computer 12 which implements step S10 constitutes the obesity-countermeasure displaying means 120.

Thus, one cycle of the execution of the main program is terminated.

It is added that, in the present embodiment, steps S5 to S10 indicated in FIG. 6 are implemented sequentially in the description order, whereby the constitution determination, the condition determination, and the obesity-related constitution determination are performed sequentially in the description order.

Alternatively, the present invention may be embodied, such that only one of these three determinations which has been selected by a user is performed, or such that at least two of these three determinations are performed in the same order that these at least two determinations have been selected by a user, for example.

As will be readily understood from the foregoing description, in the present embodiment, a human being's constitution is precisely determined by taking account of the facts as to whether tendencies of the same human being to bear in association with a plurality of items are distributed over a range of a plurality of ranks assigned to each item, such that these tendencies are concentrated at one rank, or are scattered over the range.

Suppose an exemplified case where a certain examinee, which is to say, a user of a constitution determining apparatus constructed according to the present embodiment, has selected, on the first table for determining constitution depicted in FIG. 8, the rank showing that the user's body temperature is “extremely” low in association with “body temperature” denoted at “item number 35,” together with the rank showing that the user “extremely” likes weak taste in association with “bias of taste” denoted at “item number 43.”

In general, the phenomenon that the body temperature is extremely low inherently shows that the examinee's constitution is yin-natured, and conversely, the phenomenon that the examinee extremely likes weak taste inherently shows that his or her constitution is yang-natured.

According to the conventional technology disclosed in the aforementioned Japanese publication of un-examined utility Model application Showa 55-137614, a human being's constitution is determined as one of a yin-, a medium, and a yang-nature, on the basis of sums of a plurality of selection results of ranks, by not relying at all on how the plurality of selection results have been dispersed.

For this reason, this conventional technology, if applied in the above hypothetical case, would determine the above examinee's constitution as medium-natured. A medium-nature is denoted at “E” in FIGS. 11 and 12.

By contrast, in the present embodiment, a human being's constitution is determined by taking account of how a plurality of selection results of ranks have been dispersed. Consequently, the present embodiment, if applied in the above hypothetical case, would determine the above examinee's constitution as type AD, BC, or E+, and would never determine it as type E.

Thus, the present embodiment would permit the constitution determining apparatus to determine the above hypothetical examinee's constitution, such that the resulting determination result reflects with fidelity the fact that his or her true constitution together bears a yin-, and a yang-nature, contributing to a precise determination result of his or her constitution.

As will be readily understood from the foregoing description, in the present embodiment, the server computer 12 constitutes one example of the “computer” set forth in any one of the aforementioned modes.

In addition, in the present embodiment, the constitution determining portion 80 constitutes one example of the “apparatus for determining constitution” associated with any one of the above modes (1), (4), (5), (6), and (7), and the obesity-related constitution determining portion 110 constitutes one example of the “apparatus for determining constitution” associated with any one of the above modes (1), (4), (7), and (13).

Moreover, in the present embodiment, each of a portion of the server computer 12 which implements steps S31 to S34 indicated in FIG. 7, and a portion of the server computer 12 which implements steps S91 and S92 indicated in FIG. 19, constitutes one example of the “rank selecting means” set forth in the above mode (1) or (17).

Furthermore, in the present embodiment, each of a portion of the server computer 12 which implements steps S35 to S40 indicated in FIG. 7, and a portion of the server computer 12 which implements steps S93 to S96 indicated in FIG. 19, constitutes one example of the “constitution displaying means” set forth in the above mode (1) or (17).

Additionally, in the present embodiment, each of the questions displaying means 82 included in the constitution determining portion 80, and the questions displaying means 112 included in the obesity-related constitution determining portion 110, constitutes one example of the “questions displaying means” set forth in the above mode (4).

Still additionally, in the present embodiment, each of the constitution displaying means 84 included in the constitution determining portion 80, and the obesity-related constitution displaying means 114 included in the obesity-related constitution determining portion 110, constitutes one example of the “constitution displaying means” set forth in the above mode (4).

Further, in the present embodiment, the questions displaying means 82 included in the constitution determining portion 80 constitutes one example of the “questions displaying means” set forth in the above mode (5), and the constitution displaying means 84 included in the constitution determining portion 80 constitutes one example of the “constitution displaying means” set forth in the above mode (5).

Still further, in the present embodiment, each of the constitution displaying means 84 included in the constitution determining portion 80, and the obesity-related constitution displaying means 114 included in the obesity-related constitution determining portion 110, constitutes one example of the “constitution displaying means” set forth in the above mode (7).

In addition, in the present embodiment, the obesity-related constitution displaying means 114 constitutes one example of the “obesity-related constitution displaying means” set forth in the above mode (13).

Moreover, in the present embodiment, the server computer 12 constitutes one example of the “server computer for determining constitution” associated with the above mode (17), and the screen 42 of the client computer 10 constitutes one example of the “screen” set forth in the above mode (17).

Furthermore, in the present embodiment, the proper-diet-plan advising portion 92 constitutes one example of the “system for supporting in providing advice on proper-diet-plan” associated with the above mode (18) or (19), the constitution determining portion 80 and the obesity-related constitution determining portion 110 each constitute one example of the “apparatus for determining constitution” set forth in the above mode (18), the proper-diet-plan memory 66 and the obesity countermeasure memory 70 each constitute one example of the “proper-diet-plan memory” set forth in the above mode (18), the proper-diet-plan displaying means 94 and the obesity countermeasure displaying means 120 each constitute one example of the “proper-diet-plan displaying means” set forth in the above mode (18), and the proper-diet-plan and the diet plan include in the obesity countermeasure each constitute one example of the “proper-diet-plan” set forth in the above mode (19).

Additionally, in the present embodiment, the constitution determining portion 80 constitutes one example of the “apparatus for determining constitution” set forth in the above mode (20), and the condition determining portion 96 constitutes one example of the “apparatus for determining condition” set forth in the above (20).

Still additionally, in the present embodiment, the constitution determination program and the obesity-related constitution determination program, each of which is executed by the server computer 12, constitute one example of the “computer program” associated with the above mode (22) and (24), respectively.

Further, in the present embodiment, a set of steps S31 to S34 indicated in FIG. 7 and a set of steps S91 and S92 indicated in FIG. 19 constitute one example of the “rank selecting step” set forth in the above mode (22) and (24), respectively, and a set of steps S35 to S40 indicated in FIG. 7 and a set of steps S93 to S96 indicated in FIG. 19 constitute one example of the “constitution displaying step” set forth in the above mode (22) and (24), respectively.

Still further, in the present embodiment, the memory 52 constitutes one example of the “storage medium” associated with the above mode (23) or (25).

There will be next described a second embodiment of the present invention.

This embodiment is identical with the first embodiment in many aspects, and is different from the first embodiment in only elements associated with the first table for determining constitution. The same reference numerals or names as used in the first embodiment will be used in the second embodiment to identify the functionally corresponding elements, and only the elements characteristic of the second embodiment will be described in the interest of simplification of the description.

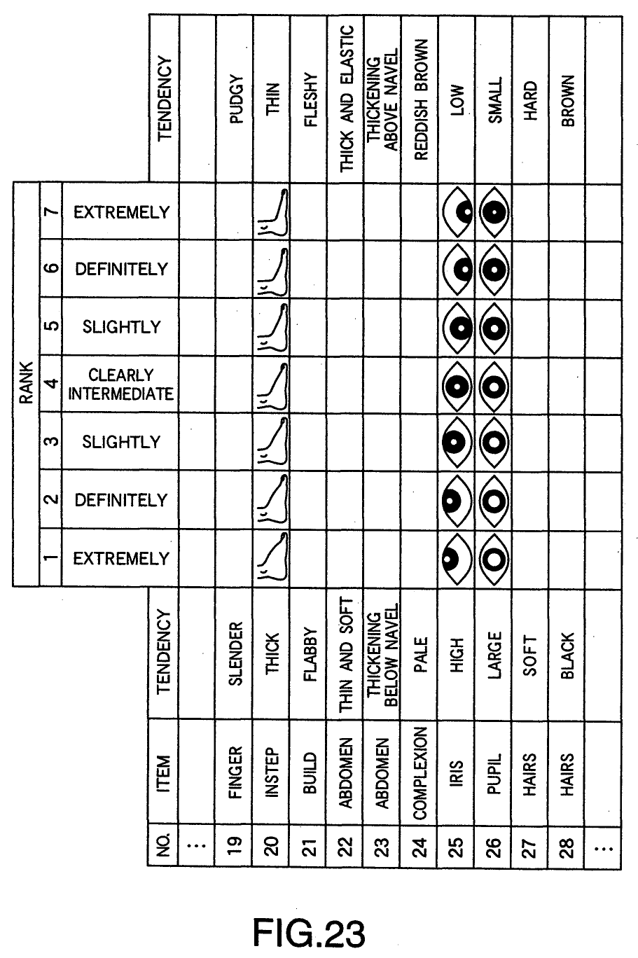

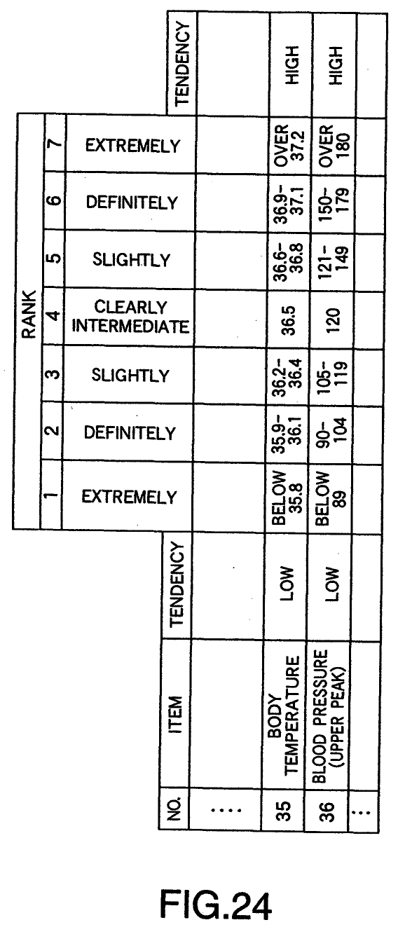

Referring then to FIGS. 23 and 24, there are illustrated two respective fragmentations of a first table for determining constitution according to the present embodiment.

More specifically, in FIG. 23, there is illustrated with a screen image ones of a plurality of items appearing on the first table, to which ones item numbers 19 to 28 have been assigned. Alternately, in FIG. 24, there is illustrated with a screen image ones of the plurality of items, to which ones item numbers 35 and 36 have been assigned. Those items, whose item numbers are 19 to 28, 35 and 36, are substantially the same in content as corresponding ones used in the first embodiment. However, part of those items, whose item numbers are 20, 25, 26, 35 and 36 is presented to a user with specific and absolute expressions using figures or numerals in the present embodiment, while the same part is presented to a user not with specific and absolute expressions but with abstract and relative expressions.

For example, the item, whose item number is 20, and whose name is “instep” is presented to a user, in the present embodiment, with a plurality of figures depicting insteps different in height.

These figures are arranged in one direction such that the instep represented by each figure is gradually lowered, thereby indicating that the instep represented by each figure is gradually lowered from the left side to the right side in FIG. 23, which is to say, as the rank number is increased from 1 to 7.

For the reason stated above, in the present embodiment, a user is allowed to select one of the plurality of ranks, by selecting one of the plurality of figures which the most precisely approximates the shape of the user's instep.

In addition, in the first embodiment, a user is required to associate each of the abstract terms (i.e., “extremely,” “definitely,” “slightly,” and “clearly intermediate”), which represent the contents of the respective ranks, with the height of instep corresponding to each rank, and subsequently, to instinctively select one of the plurality of ranks which the most precisely approximates the height of the user's instep.

As another example, the item, whose item number is 35, and whose name is “body temperature” is presented to a user, in the present embodiment, with a plurality of numerals indicating different body-temperatures.

These numerals are arranged in one direction such that the body temperature represented by each numeral is gradually elevated, thereby indicating that the body temperature represented by each numeral is gradually elevated from the left side to the right side in FIG. 24, which is to say, as the rank number is increased from 1 to 7.

For the reason stated above, in the present embodiment, a user is allowed to select one of the plurality of ranks, by selecting one of the plurality of numerals which the most precisely represents the user's body temperature.

In addition, in the first embodiment, a user is required to associate each of the abstract terms that represent the contents of the respective ranks, with the body temperature corresponding to each rank, and subsequently, to instinctively select one of the plurality of ranks which the most precisely approximates the user's body temperature.

To the contrary, in the present embodiment, as to selected ones of the plurality of items used in the first table for determining constitution, the contents of a plurality of ranks per item are definitely and absolutely expressed with figures or numerals.

Consequently, the present embodiment would more readily facilitate to improve the confidence in a user's answers to questions included in the first table for determining constitution, than the first embodiment would.

There will be next described a third embodiment of the present invention.

This embodiment is identical with the first embodiment in a major portion of the software construction and the hardware construction, and is different from the first embodiment in only a part of the software construction. The same reference numerals or names as used in the first embodiment will be used in the third embodiment to identify the functionally corresponding elements, and only the elements characteristic of the third embodiment will be described in the interest of simplification of the description.

In the first embodiment, as described above, a user's constitution is determined on the basis of the user's answers to the questions included in the first and the second table for determining constitution.

Alternatively, in the present embodiment, a user's constitution is determined, on the basis of image data indicative of the image of the user's face, not on the basis of the user's answers to questions.

In the present embodiment, the image data is utilized for permitting the user to select a desired rank with regard to ones of the plurality of items used in the first table for determining constitution, which ones are concerned with the geometrical features of the user's face.

Described more particularly, in the present embodiment, the user is required to produce the image data in a digital manner, by taking a photograph of his or her face with a digital camera, or by reading with a photograph of his or her face with a conventional camera. The thus produced image data is transmitted from the client computer 10 through the communication network 16 to the server computer 200.

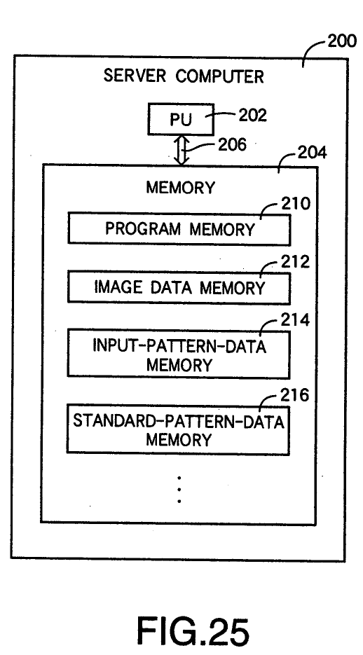

Referring next to FIG. 25, there is schematically illustrated with a block diagram the construction of the server computer 200. The server computer 200 is configured to determine the user's constitution by employing basically the same construction and principle as the server computer 12 in the first embodiment adopts.

As shown in FIG. 25, the server computer 200 is structured such that a PU 202 and a memory 204 are interconnected through a bus 206. The memory 204 contains a program memory 210 basically identical with the program memory 60 in the first embodiment.

The memory 204 further contains an image data memory 212, an input pattern-data memory 214, and a standard pattern-data memory 216.

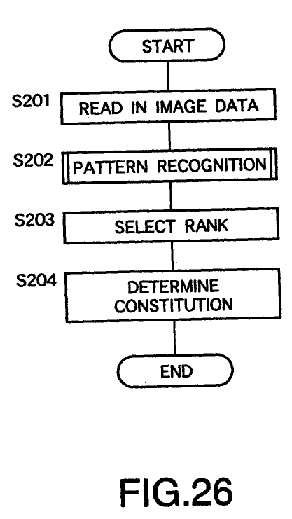

Referring next to FIG. 26, there is schematically illustrated with a flow chart a constitution determination program stored in the program memory 210.

The constitution determination program is initiated with step S201 in which the server computer 200 receives the image data from the client computer 10. The received image data is stored in the image data memory 212.

Thereafter, in step S202, pattern recognition is performed for the stored image data.

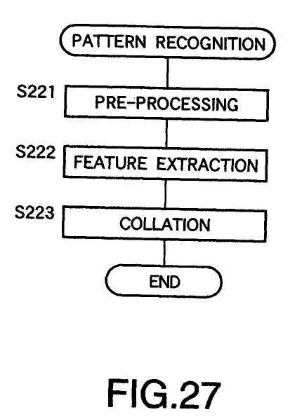

Referring next to FIG. 27, there is schematically illustrated with a flow chart the details of step S202 by the name of pattern recognition routine.

The pattern recognition routine is initiated with step S221 in which a necessary pre-processing is performed for the stored image data. The pre-processing may be defined to include the processing to transform an original image into a line figure drawn with lines, for example.

Thereafter, in step S222, feature extraction is performed for the image data received the above pre-processing.

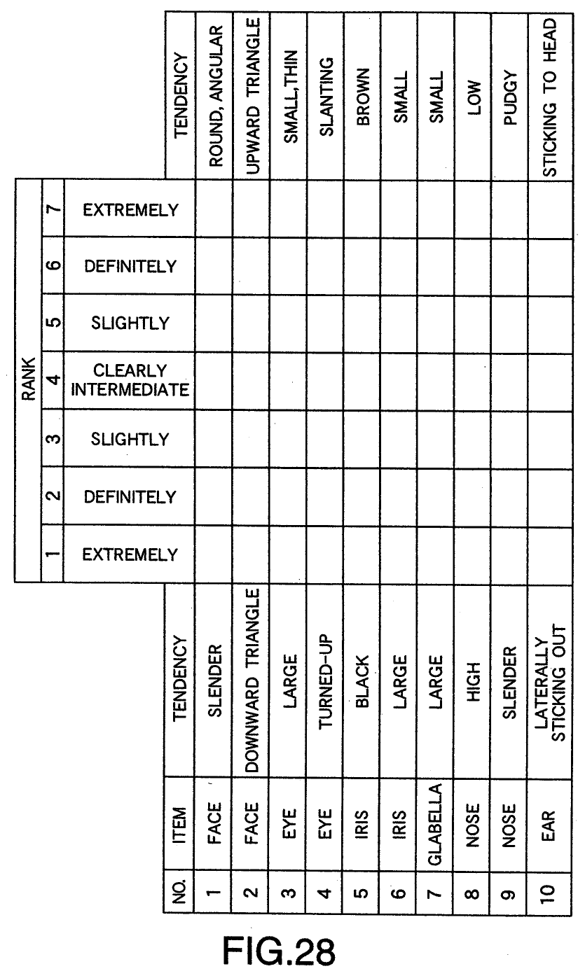

In the present embodiment, the user's constitution is determined only by referring to features of his or her face. These features include, as shown in FIG. 28, the outer shape of the whole face; and the natures and conditions (e.g., sizes, orientations, colors, etc.) of some organs of the face. These organs include the whole eyes; the iris; the glabella; the nose; and the ears.

To this end, in step S222, the above feature extraction is performed to extract from the image data received the above pre-processing, the outer shape of the whole face; the outer shape of the whole eyes; the iris; the glabella; the nose; and the ears, as the representative features of the user's face.

As a result of the feature extraction, there is produced an input pattern data indicative of the image of the user's face, which data is stored into the input pattern data memory 214.

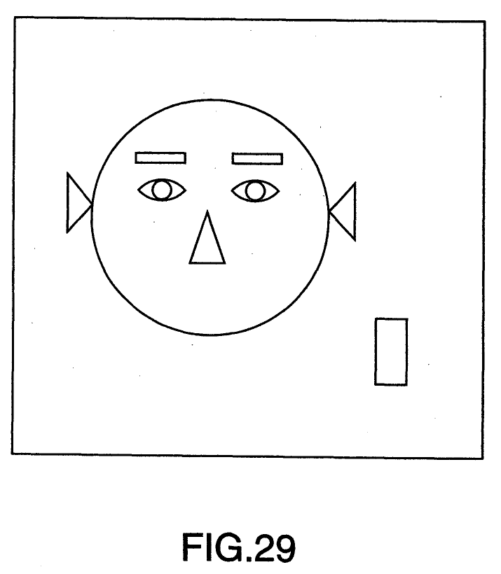

Referring next to FIG. 29, there is illustrated one example of an input pattern represented by the input pattern data. In this example, each feature of the user's face is expressed with the aforementioned line figure.

Afterward, in step S223, the produced input pattern data is collated, per feature of the user's face, with a predetermined plurality sets of standard pattern data, in a sequential manner. That is, a so-called pattern matching is performed. Those sets of standard pattern data have been stored in the standard pattern-data memory 216 in association with the plurality of ranks (as shown in FIG. 28).

A proper pattern-matching requires an advance knowledge of the absolute dimension of the face represented by the input pattern data. To satisfy this requirement, in the present embodiment, as shown in FIG. 29, the user is required to produce the image data by taking a photograph of his or her face together with an object (shown in as a quadrangle in FIG. 29) having its known absolute dimensions.

As a result of the performance of the pattern matching per feature of the user's face, there is selected, per feature of the user's face, as an approximate standard pattern, one of a plurality of standard patterns respectively represented by the plurality sets of standard pattern data. The one standard pattern the most resembles the input pattern represented by the current input pattern data, among all the standard patterns.

Subsequently, in step S203 indicated in FIG. 26, one of the plurality of ranks which corresponds to the selected approximate standard pattern is read out from the standard pattern-data memory 216, per feature of the user's face. The read-out rank means the rank to be selected for each item indicated in FIG. 28.

Following that, in step S204, the user's constitution is determined, on the basis of the rank thus selected per item, under the same principle as adopted in the first embodiment.

Thus, one cycle of the execution of the constitution determination program is terminated.

As will be readily understood from the foregoing description, in the present embodiment, a portion of the server computer 200 which implements steps S201 to S203 constitutes one example of the “rank selecting means” set forth in the above mode (26).

Further, in the present embodiment, the constitution determination program stored in the program memory 210 constitutes one example of the “computer program for determining constitution” associated with the above mode (22) or (28).

There will be next described a fourth embodiment of the present invention.

As previously described, in the first embodiment, a user's constitution is determined according to his or her answers to questions, and a proper-diet-plan compatible with the determined constitution is provided to the user.

On the other hand, in the present embodiment which is directed to a constitution-oriented beverage providing method, a customer who intends to select and purchase one of a plurality kinds of beverages at a store in which beverages as liquid intakes are provided to customers, is determined of his or her constitution, prior to the selection of beverage.

In the present embodiment, further, one of the plurality kinds of beverages, which, one is suitable to the determination results, is provided to the customer.

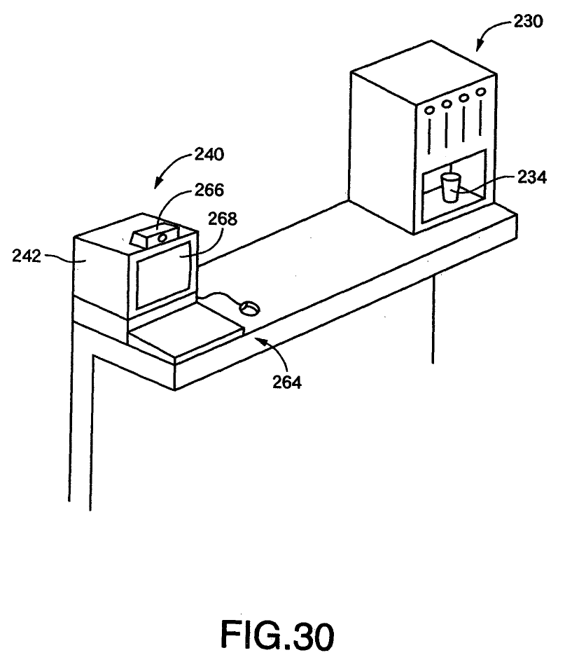

As shown in FIG. 30, the store in which the present embodiment is practiced is equipped with a beverage server 230. Upon a customer's selection of one of plurality of buttons of the beverage server 230, as functioning a plurality of its handles, it pours one of the plurality kinds of beverages which corresponds to the selected button, into a glass 232 placed at a predetermined pouring location.

The store is also equipped with a constitution determining system 240. The constitution determining system 240 is adapted to automatically determine a customer's constitution, on the basis of image data indicative of an image of the customer's face, not on the basis of the customer's answers to questions.

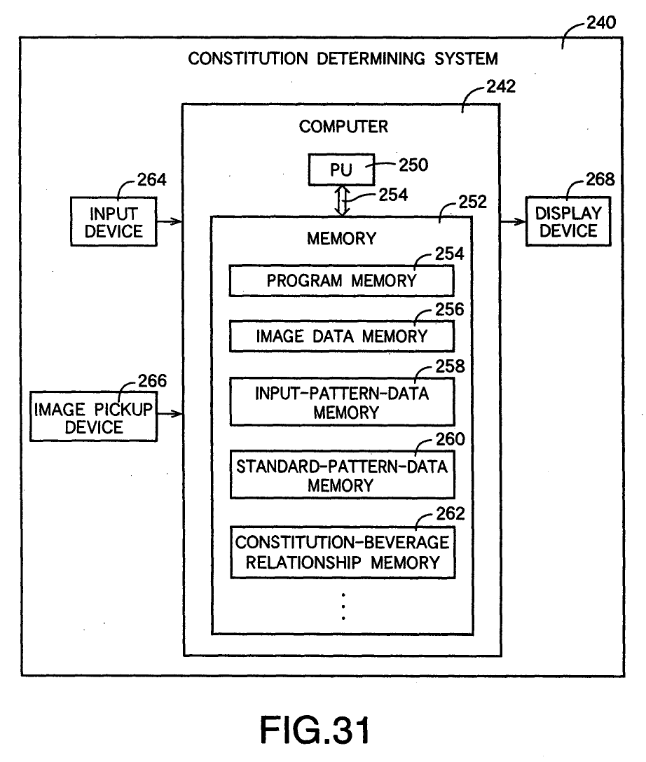

As shown in FIG. 31, the constitution determining system 240 contains a computer 242 which is constructed in the same manner as the server computer 200 in the third embodiment. The computer 242 is constructed such that a PU 250 and a memory 252 are interconnected through a bus 254.

The memory 252 contains, like the memory 204 in the third embodiment, a program memory 254; an image data memory 256; an input pattern-data memory 258; and a standard pattern-data memory 260. Programs and sets of data which are stored in each memory 254, 256, 258, and 260 are identical in content with the corresponding ones in the third embodiment, and the program memory 254 stores a constitution determination program, for example. The memory 252 further contains a constitution-beverage relationship memory 262.

As shown in FIG. 31, the computer 242 is connected on its input side with an input device 264 which is constructed similarly with the input device 40 in the first embodiment. The computer 242 is further connected on its input side with an image pickup device 266. The image pickup device 266 is adapted to take a photograph of a customer's face, and to produce image data indicative of the image of the face. One example of the image pickup device 266 is a digital camera.

The computer 242 is connected, on the other hand, on its output side with a display device 268 as constructed similarly with the display device 46 in the first embodiment. The display device 268 is equipped with a screen for visualizing data to be outputted.

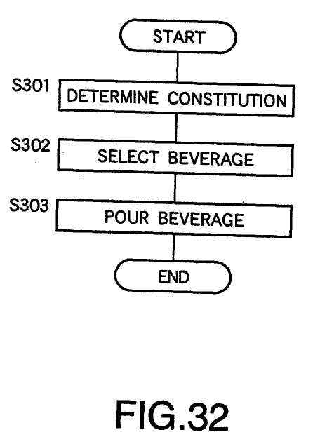

Referring next to FIG. 32, there is schematically illustrated with a flow chart a series of procedures to be followed for each customer at the store.

The series of procedures is initiated with step S301 in which a customer who requests to purchase a beverage is determined of his or her constitution. The constitution determination is performed, such that a photograph of the customer's face is first taken with the image pickup device 226, and the customer's constitution is next determined, on the basis of the image data produced as a result of operation of the image pickup device 226, in the same manner as in the third embodiment.

Following that, in step S302, one of the plurality kinds of beverages which is suited to the determined constitution has been selected. There has been stored in the constitution-beverage relationship memory 262, data indicative of the relationship between the plurality types of constitutions (i.e., the ten types used in the first embodiment), and the plurality kinds of beverages. According to the relationship, the kind of beverage corresponding to the current customer's constitution is selected. The selected kind of beverage is displayed on the screen of the display device 268.

Thereafter, in step S303, once a clerk in the store or the customer himself or herself selects on the beverage server 230 one of the buttons corresponding to the selected kind of beverage, the beverage server 230 pours the beverage in the glass.

Thus, the series of procedures to be followed per customer at the store is terminated.

As will be readily understood from the foregoing description, in the present embodiment, step S301 indicated in FIG. 32 constitutes one example of the “constitution determining step” set forth in the above mode (27), and step S302 constitutes one example of the “intake selecting step” set forth in the above mode (27).

Further, in the present embodiment, the constitution determining system 240 constitutes one example of the “apparatus for determining constitution” associated with the above mode (1), (2) or (26).

It is added that, while the constitution determining system 240 is constructed in the form of a standalone type in the present embodiment, it may be realized in the form of a client computer connected with a network, like in the first embodiment.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An apparatus for determining a constitution of an arbitrary user of the apparatus, by the use of a computer, comprising:
rank selecting means for selecting, for each one of a plurality of items which are used for determination of the user's constitution, on the basis of data indicative of information with regard to the user himself or herself, at least one of a plurality of ranks which are used for quantitatively expressing a strength of a tendency of the user to show with regard to the each item; and
constitution displaying means for calculating, for the each item, on the basis of a selection result provided by the rank selecting means, and according to a predetermined point allocation which defines how may points are allocated to each one of the plurality of ranks when selected, a score of the each rank; for summing, for the each rank, a plurality of scores obtained by the calculating with regard to all the plurality of items, thereby determining, on the basis of a distribution pattern of a plurality of sums respectively obtained by the summing for the plurality of ranks, wherein the distribution pattern reflects how a population consisting of the plurality of sums is scattered over a range of the plurality of ranks, and according to a predetermined determination rule, the user's constitution as one of a predetermined plurality of types; and for displaying the determined constitution on a screen of the computer.

2. The apparatus according to claim 1, wherein the rank selecting means includes:
questions displaying means for displaying on the screen questions which are to be answered by the user, wherein the questions are constructed, such that the questions are classified into the plurality of items, and such that the questions bear the plurality of ranks for the each item; and
selecting means for selecting at least one of the plurality of ranks, on the basis of input data entered by the user according to contents of the questions displayed on the screen.

3. The apparatus according to claim 1, wherein the data indicative of information with regard to the user himself or herself includes image data indicative of an image of at least one portion of a human body of the user, and the rank selecting means selects the at least one of the plurality of ranks, on the basis of the image data, without depending on the user's answers to questions for determining his or her constitution.

4. An apparatus for determining a constitution of an arbitrary user of the apparatus, by the use of a computer, comprising:
questions displaying means for displaying on a screen of the computer questions which are to be answered by the user, wherein the questions are constructed, such that the questions are classified into a plurality of items which are used for determination of the user's constitution, and such that the questions bear, for each one of the plurality of items, a plurality of ranks which are used for quantitatively expressing a strength of a tendency of the user to show with regard to the each item, wherein at least one of the plurality of ranks is to be selected by the user for the each item; and
constitution displaying means for selecting, for the each item, on the basis of data indicative of the user's answers to the questions displayed on the screen, at least one of the plurality of ranks; for calculating, on the basis of a selection result obtained by the selecting, and according to a predetermined point allocation which defines how may points are allocated to each one of the plurality of ranks when selected, a score of the each rank; for summing, for the each rank, a plurality of scores obtained by the calculating with regard to all the plurality of items, thereby determining, on the basis of a distribution pattern of a plurality of sums respectively obtained by the summing for the plurality of ranks, wherein the distribution pattern reflects how a population consisting of the plurality of sums is scattered over a range of the plurality of ranks, and according to a predetermined determination rule, the user's constitution as one of a predetermined plurality of types; and for displaying the determined constitution on the screen.

5. The apparatus according to claim 4, wherein the questions displaying means displays the questions on the screen at at least two separate times, irrespective of whether or not parts of the questions which are displayed at the at least two separate times, respectively, are overlapped in content to each other; and
the constitution displaying means includes:
(a) provisionally determining means for obtaining the plurality of sums, on the basis of data indicative of the user's answers to part of the questions which is displayed at a first time on the screen by the questions displaying means; and for provisionally determining the user's constitution as at least one of the plurality of types, on the basis of the distribution pattern of the obtained plurality of sums, and according to a predetermined first determination rule; and
(b) finally determining means for finally determining the user's constitution as one of the provisionally determined at least one type, on the basis of data indicative of the user's answers to part of the questions which is displayed at a time succeeding the first time on the screen by the questions displaying means, and according to a predetermined second determination rule.

6. The apparatus according to claim 1, wherein the number of the plurality of ranks is larger than that of at least one basic type among the predetermined plurality of types, which basic type is established independently of other types.

7. The apparatus according to claim 1, wherein the predetermined plurality of types comprise a plurality of basic types each of which is established independently of other types; and at least one compound type obtained by compounding selected ones of the plurality of basic types, and
the constitution displaying means determines, when the distribution pattern demonstrates that the plurality of sums are distributed so as to be scattered at ones of the plurality of ranks, the user's constitution as one of the at least one compound type.

8. A method of providing a customer with a selected one of a plurality kinds of oral intakes including at least one of a food and a beverage, which selected one is compatible with the customer's constitution, comprising:
a constitution determining step of determining the customer's constitution, by operating, prior to selection from the plurality kinds of oral intakes, the apparatus defined in claim 1; and
an oral intake selecting step of selecting at least one of the plurality kinds of oral intakes which corresponds to the determined constitution, according to a predetermined selection rule.

9. A server computer which is connected through a communication network to a client computer with a screen as used by a user, and which is operated to determine the user's constitution, comprising:
rank selecting means for selecting, for each one of a plurality of items which are used for determination of the user's constitution, on the basis of data indicative of information with regard to the user himself or herself, at least one of a plurality of ranks which are used for quantitatively expressing a strength of a tendency of the user to show with regard to the each item; and
constitution displaying means for calculating, for the each item, on the basis of a selection result provided by the rank selecting means, and according to a predetermined point allocation which defines how may points are allocated to each one of the plurality of ranks when selected, a score of the each rank; for summing, for the each rank, a plurality of scores obtained by the calculating with regard to all the plurality of items, thereby determining, on the basis of a distribution pattern of a plurality of sums respectively obtained by the summing for the plurality of ranks, wherein the distribution pattern reflects how a population consisting of the plurality of sums is scattered over a range of the plurality of ranks, and according to a predetermined determination rule, the user's constitution as one of a predetermined plurality of types; and for instructing the client computer to display the determined constitution on the screen.

10. A system for supporting, by the use of a computer with a screen, in advising for a user of the system a proper-diet-plan suitable to the user, comprising:
the apparatus defined in claim 1;
a proper-diet-plan memory in which there has been stored a relationship between a plurality kinds of constitutions presupposed for human beings, and a plurality kinds of proper-diet-plans presupposed for human beings' diets; and
proper-diet-plan displaying means for retrieving in the proper-diet-plan memory the proper-diet-plan suitable to the user, on the basis of the constitution determined by the apparatus defined in claim 1; and for displaying the retrieved proper-diet-plan on the screen.

11. The system according to claim 10, wherein each of the plurality kinds of proper-diet-plans is defined to provide a proper diet which is suitable to the user's constitution, and which contributes to an improvement in the user's constitution toward a medium one, to the user, in the form of a recipe for practicing the proper diet.

12. A system for determining a constitution and a condition, of an arbitrary user of the system, by the use of a computer, comprising:
the apparatus defined in claim 1; and
an apparatus for determining the user's condition by the use of a computer with a screen, including:
(a) questions displaying means for displaying on the screen questions to be answered by the user, wherein the questions are constructed so as to be classified into a plurality of items used for determining the user's condition; and
(b) condition displaying means for determining, on the basis of data indicative of the user's answers to the questions displayed on the screen, and according to a predetermined determination rule, the user's condition as one of a predetermined plurality of types; and for displaying the determined condition on the screen.

13. A computer program to be executed by a computer for determining a constitution of an arbitrary user of the computer, by implementing a method comprising:
a rank selecting step of selecting, for each one of a plurality of items which are used for determination of the user's constitution, on the basis of data indicative of information with regard to the user himself or herself, at least one of a plurality of ranks which are used for quantitatively expressing a strength of a tendency of the user to show with regard to the each item; and
a constitution displaying step of calculating, for the each item, on the basis of a selection result provided by the rank selecting step, and according to a predetermined point allocation which defines how may points are allocated to each one of the plurality of ranks when selected, a score of the each rank; of summing, for the each rank, a plurality of scores obtained by the calculating with regard to all the plurality of items, thereby determining, on the basis of a distribution pattern of a plurality of sums respectively obtained by the summing for the plurality of ranks, wherein the distribution pattern reflects how a population consisting of the plurality of sums is scattered over a range of the plurality of ranks, and according to a predetermined determination rule, the user's constitution as one of a predetermined plurality of types; and of displaying the determined constitution on a screen of the computer.

14. A computer-readable storage medium in which the computer program according to claim 13 has been stored.

15. A computer program to be executed by a computer for determining a constitution of an arbitrary user of the computer, by implementing a method comprising:
a questions displaying step of displaying on a screen of the computer questions which are to be answered by the user, wherein the questions are constructed, such that the questions are classified into a plurality of items which are used for determination of the user's constitution, and such that the questions bear, for each one of the plurality of items, a plurality of ranks which are used for quantitatively expressing a strength of a tendency of the user to show with regard to the each item, wherein at least one of the plurality of ranks is to be selected by the user for the each item; and
a constitution displaying step of selecting, for the each item, on the basis of data indicative of the user's answers to the questions displayed on the screen; of calculating, on the basis of a selection result obtained by the selecting, and according to a predetermined point allocation which defines how may points are allocated to each one of the plurality of ranks when selected, a score of the each rank; of summing, for the each rank, a plurality of scores obtained by the calculating with regard to all the plurality of items, thereby determining, on the basis of a distribution pattern of a plurality of sums respectively obtained by the summing for the plurality of ranks, wherein the distribution pattern reflects how a population consisting of the plurality of sums is scattered over a range of the plurality of ranks, and according to a predetermined determination rule, the user's constitution as one of a predetermined plurality of types; and of displaying the determined constitution on the screen.

16. A computer-readable storage medium in which the computer program according to claim 15 has been stored.
